(19) United States
(12) Patent Application Publication
(10) Pub. No.: US 2012/0182576 A1
(43) Pub. Date: Jul. 19, 2012

(54) IMAGE FORMING APPARATUS, DISPLAY APPARATUS, GREENHOUSE GAS EMISSION TRADING SYSTEM AND GREENHOUSE GAS EMISSION TRADING METHOD

(76) Inventors: Yasuyuki ISHIGURO, Osaka-shi (JP); Hisashi Kunihiro, Osaka-shi (JP); Hitoshi Nagahama, Osaka-shi (JP)

(21) Appl. No.: 13/349,192

(22) Filed: Jan. 12, 2012

(30) Foreign Application Priority Data
Jan. 13, 2011 (JP) 2011-005337
Dec. 14, 2011 (JP) 2011-273765

(51) Int. Cl. G06F 3/12

(52) U.S. Cl. 358/1.15

(57) ABSTRACT

A control unit displays on the display unit, when a device and a life cycle phase for which an acquisition equivalent and an actual equivalent are desired to be acquired are selected on a selected screen displayed on a display unit and a “SEND” icon is manipulated, the acquisition equivalent, the actual equivalent and a comparison result between them which are received from a server. When a user refers to the comparison result displayed on the display unit and manipulates a “SEND STATEMENT OF ACCOUNT” icon on a settlement screen, the control unit sends a statement of account to the server.

### CROSS-REFERENCE TO RELATED APPLICATION

This application claims priority to Japanese Patent Application Nos. 2011-005337 and 2011-273765, which were filed on Jan. 13, 2011 and Dec. 14, 2011, the contents of which are incorporated herein by reference in its entirety.

### BACKGROUND OF THE TECHNOLOGY

1. Field of the Technology

The present technology relates to an image forming apparatus, a display apparatus, a greenhouse gas emission trading system and a greenhouse gas emission trading method capable of promoting greenhouse gas emission reduction.

2. Description of the Related Art

There has been proposed a carbon offset as an idea for reducing emissions of greenhouse gases such as carbon dioxide. The carbon offset means activities for compensating for all or a part of the emissions, which is difficult to be reduced even though citizens, companies, governments, and other social entities recognize their own greenhouse gas emissions and make efforts to voluntarily reduce their emissions together, by purchasing a reduction or absorption amount (hereinafter, referred to as “credits”) of greenhouse gas emissions realized in other positions, carrying out projects and activities for reducing and absorbing greenhouse gas emissions in other positions, or the like.

As one carbon offset initiative, there is a trade in greenhouse gas emission rights. For example, emission rights, corresponding to greenhouse gas emission discharged to generate electricity consumed by the image forming apparatus during an operational time period thereof, are purchased by a manufacturer or a vendor as a credit on behalf of a user and are provided to the user who purchases the image forming apparatus or the like. For example, as a credit, there is a Kyoto mechanism credit issued on the basis of procedures determined by the Kyoto Protocol.

As a conventional art concerning transfer of emission rights of greenhouse gases, there is an electronic apparatus that is described in Japanese Unexamined Patent Publication JP-A 2010-2442. This electronic apparatus uses a consumables unit that is sold in a form in which emission rights of greenhouse gases are granted as a consumables unit attachable/detachable to/from the electronic apparatus. Then, evaluation is performed for reduction of greenhouse gases according to a continued usage state of this consumables unit, and the evaluation result is displayed on a manipulation panel or the like, or printed on a sheet. Thereby, user's awareness of greenhouse gas reduction is attempted to be increased.

However, in the above-described conventional art, a consumables unit is assumed which is sold in the form in which emission rights have already been granted, however, consumables which are already on the market and sold in a form in which emission rights are not granted are not considered. Therefore, it is necessary for a user to perform replacement or newly lease in place of an image forming apparatus and optional devices in which consumables that are sold in a form in which emission rights are not granted are still usable with an image forming apparatus or optional devices for which consumables that are sold in a form in which emission rights are granted, which increases the cost to be borne by the user.

### SUMMARY OF THE TECHNOLOGY

An object of the technology is to provide an image forming apparatus, a display apparatus, a greenhouse gas emission trading system and a greenhouse gas emission trading method capable of promoting greenhouse gas emission reduction also for consumables, an image forming apparatus and optional devices for which emission rights are not granted.

The technology provides an image forming apparatus for forming an image including:

an acquisition unit that acquires acquisition equivalent information indicating an acquisition equivalent in which an emission amount of greenhouse gases which are emitted by operation of the image forming apparatus, for which greenhouse gases emission rights are acquired, is converted to an emission amount of carbon dioxide, and actual equivalent information indicating an actual equivalent in which an emission amount of greenhouse gases which are emitted by operation of the image forming apparatus is converted to an emission amount of carbon dioxide, from a server that stores the acquisition equivalent information and the actual equivalent information and settles cost of emission rights;

a comparison unit that compares the acquisition equivalent indicated by the acquisition equivalent information that is acquired by the acquisition unit to the actual equivalent indicated by the actual equivalent information that is acquired by the acquisition unit;

a display unit that displays a comparison result of comparison performed by the comparison unit; and

a settlement unit that requests the server to settle cost for emission rights of greenhouse gases that are equal to a carbon dioxide equivalent which is a difference between the actual equivalent and the acquisition equivalent when the comparison result of comparison performed by the comparison unit shows that the actual equivalent is larger than the acquisition equivalent.

In the case of forming an image, the acquisition unit acquires acquisition equivalent information indicating an acquisition equivalent in which an emission amount of greenhouse gases which are emitted by operation of the image forming apparatus, for which greenhouse gases emission rights are acquired, is converted to an emission amount of carbon dioxide, and actual equivalent information indicating an actual equivalent in which an emission amount of greenhouse gases which are emitted by operation of the image forming apparatus is converted to an emission amount of carbon dioxide, from a server that stores the acquisition equivalent information and the actual equivalent information and settles cost of emission rights. The comparison unit compares the acquisition equivalent indicated by the acquisition equivalent information that is acquired by the acquisition unit to the actual equivalent indicated by the actual equivalent information that is acquired by the acquisition unit. The display unit displays a comparison result of comparison performed by the comparison unit. Then, the settlement unit is able to request the server to settle cost for emission rights of greenhouse gases that are equal to a carbon dioxide equivalent which is a difference between the actual equivalent and the acquisition equivalent when the comparison result of comparison performed by the comparison unit shows that the actual equivalent is larger than the acquisition equivalent.

Therefore, it is possible for a user to settle emission rights that are equal to the exceeded emission amount even when greenhouse gases that exceed an emission amount of greenhouse gases for which emission rights are granted are emitted, thus there is no need to purchase emission rights of greenhouse gases at the time of purchase of an image forming apparatus or the like, so that it is possible to purchase or lease a less expensive image forming apparatus or the like for which emission rights are not granted. Additionally, the user is able to settle the emission rights according to a use status so that it is possible to reduce a usage maintenance cost which is expense required for using and maintaining an image forming apparatus or the like. Further, the user is able to suppress emission of greenhouse gases by reducing a use frequency without performing replacement or new leasing of an image forming apparatus or the like that is still usable. Namely, even for consumables, an image forming apparatus and optional devices for which emission rights are not granted, it is possible to promote greenhouse gas emission reduction. Moreover, the user recognizes an equivalent that is converted to carbon dioxide of greenhouse gases emitted in an image forming apparatus or the like which is used by the user each time emission rights are settled, thus making it possible to promote replacement with or leasing to a model with less generation of greenhouse gases in a case where the image forming apparatus or the like which is used by the user is a model which generates a large amount of greenhouse gases, and eventually contribute to prevention of global warming, so that receiving an order of an image forming apparatus or the like is facilitated, thereby making it possible to also attempt increase of sales at a dealer or a leasing store.

Further, it is preferable that the emission rights are acquired by a manufacturer or a dealer of the image forming apparatus.

The emission rights are acquired by a manufacturer or a dealer of the image forming apparatus. Therefore, a user does not need to acquire the emission rights in a straightforward manner.

Further, it is preferable that the image forming apparatus further includes a sending unit that sends an electric energy corresponding to an amount of electric power consumed for operation of an image forming apparatus, to the server, and

the actual equivalent is a value in which the server converts the electric energy sent by the sending unit to an emission amount of carbon dioxide.

The sending unit sends an electric energy corresponding to an amount of electric power consumed for operation of an image forming apparatus, to the server. Then, the actual equivalent is a value in which the server converts the electric energy sent by the sending unit to an emission amount of carbon dioxide. Therefore, there is no need to convert to an emission amount of carbon dioxide in the image forming apparatus.

Further, it is preferable that the image forming apparatus includes an image forming apparatus main body that forms an image and one or more additional devices that are added to the image forming apparatus main body, and

the emission rights include emission rights for each of the image forming apparatus main body and the additional devices, and the whole image forming apparatus.

The image forming apparatus includes an image forming apparatus main body that forms an image and one or more additional devices that are added to the image forming apparatus main body. Then, the emission rights include emission rights for each of the image forming apparatus main body and the additional devices, and the whole image forming apparatus. Therefore, it is possible to perform settlement of emission rights for each of the image forming apparatus main body and the additional devices, and the whole image forming apparatus.

Further, it is preferable that the display unit is composed of a touch panel.

The display unit is composed of a touch panel. Therefore, the touch panel integrally provided with a manipulation unit is used as a display unit of an image forming apparatus so that it is possible for a user to easily acquire directly from a server and display information to select information. Additionally, it is possible to easily use emission trading service provided by a manufacturer, a dealer, a representative or a leasing store of an image forming apparatus or the like.

Further, it is preferable that the image forming apparatus is connected to the server by a communication line including a network.

The image forming apparatus is connected to the server by a communication line including a network. Therefore, it is possible to easily use emission trading service even with an image forming apparatus that is installed in a remote location that is far from the server, so that it is possible to easily get emission trading service that is convenient for a user.

Further, it is preferable that the comparison unit creates display image data for displaying a use status of emission rights based on the comparison result of comparison by the comparison unit and the acquisition equivalent as well as the actual equivalent, and

the display unit displays the use status of the emission rights based on the display image data.

Further, the technology provides a display apparatus configured to perform data communication with the image forming apparatus mentioned above, the display apparatus including:

a receiving unit that receives the acquisition equivalent, the actual equivalent and the comparison result of comparison by the comparison unit from the image forming apparatus; and

a use status display unit that displays a use status of emission rights based on the acquisition equivalent, the actual equivalent and the comparison result that are received by the receiving unit.

Further, the technology provides a display apparatus configured to perform data communication with the image forming apparatus mentioned above, the display apparatus including:

a receiving unit that receives the display image data from the image forming apparatus; and

a use status display unit that displays a use status of emission rights based on the display image data.

Further, the technology provides a greenhouse gas emission trading system including:

an image forming apparatus that forms an image; and

a server that stores acquisition equivalent information and actual equivalent information, and settles cost of emission rights, the acquisition equivalent information indicating an acquisition equivalent in which an emission amount of greenhouse gases which are emitted by operation of the image forming apparatus, for which greenhouse gases emission rights are acquired, is converted to an emission amount of carbon dioxide, and the actual equivalent information indicating an actual equivalent in which an emission amount of greenhouse gases which are emitted by operation of the image forming apparatus is converted to an emission amount of carbon dioxide,

the image forming apparatus including
an acquisition unit that acquires the acquisition equivalent information and the actual equivalent information from the server,
a comparison unit that compares the acquisition equivalent indicated by the acquisition equivalent information that is acquired by the acquisition unit to the actual equivalent indicated by the actual equivalent information that is acquired by the acquisition unit,
a display unit that displays a comparison result of comparison performed by the comparison unit, and
a settlement unit that requests the server to settle cost for emission rights of greenhouse gases that are equal to a carbon dioxide equivalent which is a difference between the actual equivalent and the acquisition equivalent when the comparison result of comparison performed by the comparison unit shows that the actual equivalent is larger than the acquisition equivalent.

In a greenhouse gas emission trading system including an image forming apparatus that forms an image, and a server that stores acquisition equivalent information and actual equivalent information, and settles cost of emission rights, the acquisition equivalent information indicating an acquisition equivalent in which an emission amount of greenhouse gases which are emitted by operation of the image forming apparatus, for which greenhouse gases emission rights are acquired, is converted to an emission amount of carbon dioxide, and the actual equivalent information indicating an actual equivalent in which an emission amount of greenhouse gases which are emitted by operation of the image forming apparatus is converted to an emission amount of carbon dioxide, for performing emission trading of greenhouse gases, the image forming apparatus includes an acquisition unit, a comparison unit, a display unit and a settlement unit. The acquisition unit acquires the acquisition equivalent information and the actual equivalent information from the server. The comparison unit compares the acquisition equivalent indicated by the acquisition equivalent information that is acquired by the acquisition unit to the actual equivalent indicated by the actual equivalent information that is acquired by the acquisition unit. The display unit displays a comparison result of comparison performed by the comparison unit. Then, the settlement unit is able to request the server to settle cost for emission rights of greenhouse gases that are equal to a carbon dioxide equivalent which is a difference between the actual equivalent and the acquisition equivalent when the comparison result of comparison performed by the comparison unit shows that the actual equivalent is larger than the acquisition equivalent.

Therefore, it is possible for a user to settle emission rights that are equal to the exceeded emission amount even when greenhouse gases that exceed an emission amount of greenhouse gases for which emission rights are granted are emitted, thus there is no need to purchase emission rights of greenhouse gases at the time of purchase of an image forming apparatus or the like, so that it is possible to purchase or lease a less expensive image forming apparatus or the like for which emission rights are not granted. Additionally, the user is able to settle the emission rights according to a use status so that it is possible to reduce a usage maintenance cost which is expense required for using and maintaining an image forming apparatus or the like. Further, the user is able to suppress emission of greenhouse gases by reducing a use frequency without performing replacement or new leasing of an image forming apparatus or the like that is still usable. Namely, even for consumables, an image forming apparatus and optional devices for which emission rights are not granted, it is possible to promote greenhouse gas emission reduction. Moreover, the user recognizes an equivalent that is converted to carbon dioxide of greenhouse gases emitted in an image forming apparatus or the like which is used by the user each time emission rights are settled, thus making it possible to promote replacement with or leasing to a model with less generation of greenhouse gases in a case where the image forming apparatus or the like which is used by the user is a model which generates a large amount of greenhouse gases, and eventually contribute to prevention of global warming, so that receiving an order of an image forming apparatus or the like is facilitated, thereby making it possible to also attempt increase of sales at a dealer or a leasing store.

Further, the technology provides a greenhouse gas emission trading method that is executed in a greenhouse gas emission trading system including an image forming apparatus that includes a display unit and forms an image, and a server that stores acquisition equivalent information and actual equivalent information, and settles cost of emission rights, the acquisition equivalent information indicating an acquisition equivalent in which an emission amount of greenhouse gases which are emitted by operation of the image forming apparatus, for which greenhouse gases emission rights are acquired, is converted to an emission amount of carbon dioxide, and the actual equivalent information indicating an actual equivalent in which an emission amount of greenhouse gases which are emitted by operation of the image forming apparatus is converted to an emission amount of carbon dioxide, the greenhouse gas emission trading method including:

an acquisition step of acquiring the acquisition equivalent information and the actual equivalent information from the server;

a comparison step of comparing the acquisition equivalent indicated by the acquisition equivalent information that is acquired in the acquisition step to the actual equivalent indicated by the actual equivalent information that is acquired in the acquisition step;

a display step of displaying on the display unit a comparison result of comparison performed in the comparison step; and

a settlement step of requesting the server to settle cost for emission rights of greenhouse gases that are equal to a carbon dioxide equivalent which is a difference between the actual equivalent and the acquisition equivalent when the comparison result of comparison performed in the comparison step shows that the actual equivalent is larger than the acquisition equivalent.

In a greenhouse gas emission trading system including an image forming apparatus that includes a display unit and forms an image, and a server that stores acquisition equivalent information and actual equivalent information, and settles cost of emission rights, the acquisition equivalent information indicating an acquisition equivalent in which an emission amount of greenhouse gases which are emitted by operation of the image forming apparatus, for which greenhouse gases emission rights are acquired, is converted to an emission amount of carbon dioxide, and the actual equivalent information indicating an actual equivalent in which an emission amount of greenhouse gases which are emitted by operation of the image forming apparatus is converted to an emission amount of carbon dioxide, for performing emission trading of greenhouse gases, in an acquisition step, the acquisition equivalent information and the actual equivalent information are acquired from the server. In a comparison step, the acquisition equivalent indicated by the acquisition equivalent information that is acquired in the acquisition step is compared to the actual equivalent indicated by the actual equivalent information that is acquired in the acquisition step. In a display step, a comparison result of comparison performed in the comparison step is displayed on the display unit. Then, in a settlement step, it is possible to request the server to settle cost for emission rights of greenhouse gases that are equal to a carbon dioxide equivalent which is a difference between the actual equivalent and the acquisition equivalent when the comparison result of comparison performed in the comparison step shows that the actual equivalent is larger than the acquisition equivalent.

Therefore, it is possible for a user to settle emission rights that are equal to the exceeded emission amount even when greenhouse gases that exceed an emission amount of greenhouse gases for which emission rights are granted are emitted, thus there is no need to purchase emission rights of greenhouse gases at the time of purchase of an image forming apparatus or the like, so that it is possible to purchase or lease a less expensive image forming apparatus or the like for which emission rights are not granted. Additionally, the user is able to settle the emission rights according to a use status so that it is possible to reduce a usage maintenance cost which is expense required for using and maintaining an image forming apparatus or the like. Further, the user is able to suppress emission of greenhouse gases by reducing a use frequency without performing replacement or new leasing of an image forming apparatus or the like that is still usable. Namely, even for consumables, an image forming apparatus and optional devices for which emission rights are not granted, it is possible to promote greenhouse gas emission reduction. Moreover, the user recognizes an equivalent that is converted to carbon dioxide of greenhouse gases emitted in an image forming apparatus or the like which is used by the user each time emission rights are settled, thus making it possible to promote replacement with or leasing to a model with less generation of greenhouse gases in a case where the image forming apparatus or the like which is used by the user is a model which generates a large amount of greenhouse gases, and eventually contribute to prevention of global warming, so that receiving an order of an image forming apparatus or the like is facilitated, thereby making it possible to also attempt increase of sales at a dealer or a leasing store.

### BRIEF DESCRIPTION OF THE DRAWINGS

Other and further objects, features, and advantages of the technology will be more explicit from the following detailed description taken with reference to the drawings wherein:

FIG. 1 is a diagram schematically showing a configuration of a greenhouse gas emission trading system according to an embodiment;

FIG. 2 is a perspective diagram showing appearance of an image forming apparatus;

FIG. 3 is a block diagram showing a configuration of the image forming apparatus;

FIGS. 4A and 4B are diagrams showing appearance of a manipulation panel;

FIG. 5 is a diagram showing an example of a selected screen;

FIG. 6 is a diagram showing an example of a use status display screen;

FIG. 7 is a diagram showing an example of a settlement screen;

FIG. 8 is a diagram showing an example of a new product display screen;

FIG. 9 is a diagram showing an example of an emission trading order sheet screen;

FIG. 10 is a flowchart showing a processing sequence of emission rights settlement process that is executed in the emission trading system;

FIG. 11 is a perspective diagram showing appearance of an image forming apparatus provided with a large display unit;

FIGS. 12A to 12C are perspective diagrams showing appearance of an image forming apparatus provided with large display units;

FIG. 13 is a diagram showing appearance of an image forming apparatus and a display apparatus; and

FIG. 14 is a diagram showing appearance of an image forming apparatus and a display apparatus.

### DETAILED DESCRIPTION

Now referring to the drawings, preferred embodiments are described below.

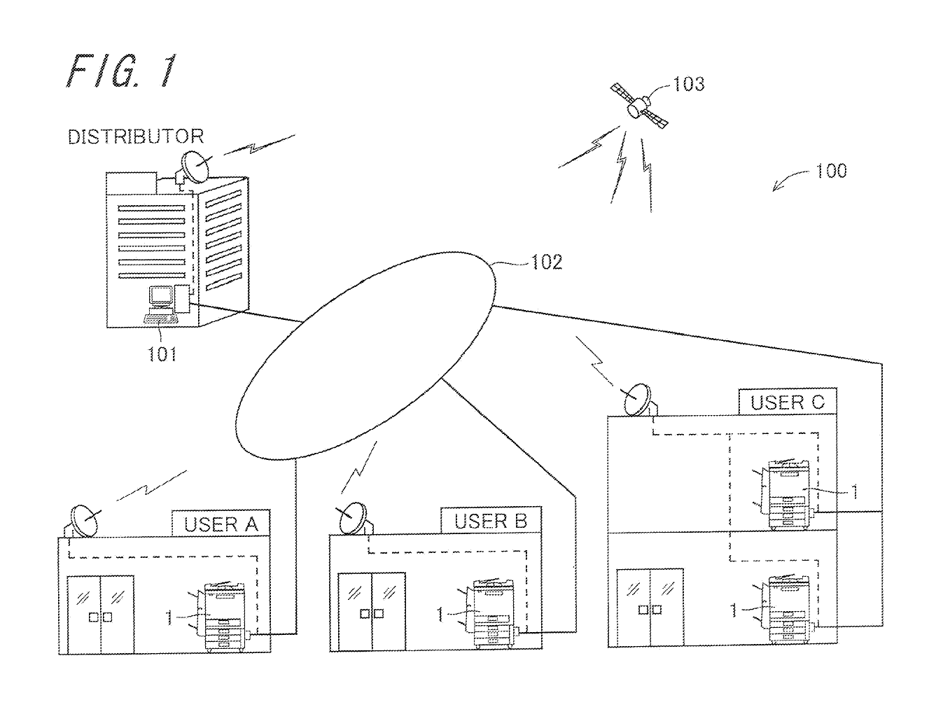

FIG. 1 is a diagram schematically showing a configuration of a greenhouse gas emission trading system (hereinafter, referred to as an “emission trading system”) 100 according to an embodiment. A greenhouse gas emission trading method according to the technology is executed in the emission trading system 100. The emission trading system 100 is composed of an image forming apparatus 1 and a server 101. One server 101 is included therein, and one or more image forming apparatus 1 may be included therein.

The image forming apparatus 1 and the server 101 are connected with a local area network (hereinafter, referred to as a “LAN”) 102, and information can be sent and received between the server 101 and the image forming apparatus 1. The communication between the image forming apparatus 1 and the server 101 is not limited to the LAN 102, but may also be available in communication networks such as the Internet, communication lines via a satellite communication apparatus 103, and Intranet, Extranet, ISDN (Integrated Services Digital Network), VAN (Value Added Network), CATV (Community Antenna Television) communication networks, virtual private networks, telephone networks, mobile communication networks, and satellite communication networks and the like. In addition, a transmission medium of the communication network is not particularly limited, but may include, for example, a wired line such as IEEE (Institute of Electrical and Electronic Engineers) 1394, USB (Universal Serial Bus), power line communication, cable TV communication, telephone lines, ADSL (Asymmetric Digital Subscriber Line), an infrared radiation such as IrDA (Infrared Data Association) or Remote controller, wireless communication such as Bluetooth (registered trademark), 802.11 wireless, HDR (High Data Rate), cellular phone networks, satellite communication network, and digital terrestrial networks. In addition, the technology may be realized in the form of computer data signals embedded in carrier waves by which the program codes are embodied as the electronic transmission.

Hereinafter, it is assumed that information can be sent and/or received using an e-mail, facsimile communication, or the like as well as in the form of directly sending and/or receiving information between the image forming apparatus 1 and the server 101 using the LAN 102.

The server 101 is provided at a distributor such as a dealer or a leasing store, or a cloud provider which provides a cloud computing service, and the image forming apparatus 1 is provided in environment where the image forming apparatus 1 is usable such as a user's company, office, store, or the like. A dealer, a representative or a leasing store (hereinafter, referred to as “dealer”) provides greenhouse gas emission trading service. The emission trading service is a service for settling emission rights for an emission amount of greenhouse gases in which the exceeded emission amount of greenhouse gases for which emission rights are granted is used. The emission rights are to provide a user who purchases an image forming apparatus 1 or the like with rights equivalent to greenhouse gases that are emitted in order to generate electricity which are consumed during a period when the image forming apparatus 1 is operated, which is purchased by a manufacturer/distributor of the image forming apparatus 1 or the like as credit on behalf of the user. Such emission rights include not only emission rights that are acquired at the time of shipment of the image forming apparatus but also emission rights that are acquired by settling cost of the emission rights after shipment.

The server 101 settles emission rights for the excess that are equal to the amount of cost for the emission rights in replacement for the cost in response to a settlement request of the emission rights from the image forming apparatus 1. The server 101 has a server storage unit (not shown) that stores acquisition equivalent information indicating an acquisition equivalent in which an emission amount of greenhouse gases which are emitted by operation of the image forming apparatus 1 and for which greenhouse gas emission rights are acquired is converted to an emission amount of carbon dioxide, and actual equivalent information indicating an actual equivalent in which an emission amount of greenhouse gases that are emitted by operation of the image forming apparatus 1 is converted to an emission amount of carbon dioxide.

The server 101 reads from the server storage unit, in response to an offer request of the acquisition equivalent information and the actual equivalent information from the image forming apparatus 1, the requested acquisition equivalent information and actual equivalent information of the image forming apparatus 1, and sends the read acquisition equivalent information and actual equivalent information to the image forming apparatus 1. The server storage unit stores the acquisition equivalent information and the actual equivalent information by image forming apparatus main body and optional devices included in the image forming apparatus 1 that are described below, as well as consumable item that is used in the image forming apparatus, also as the whole image forming apparatus.

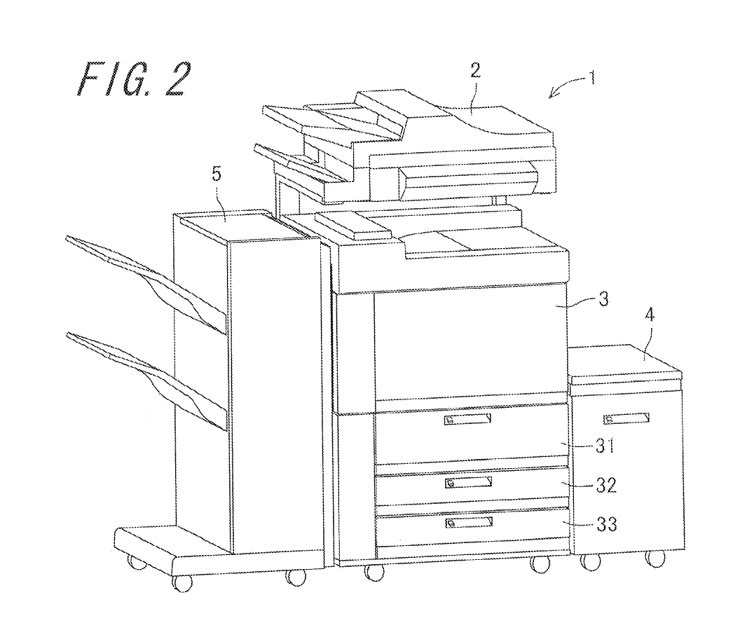

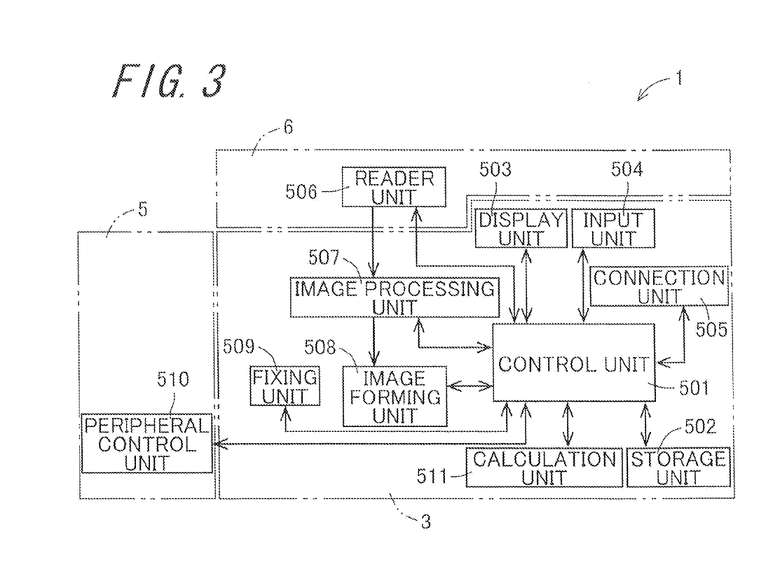

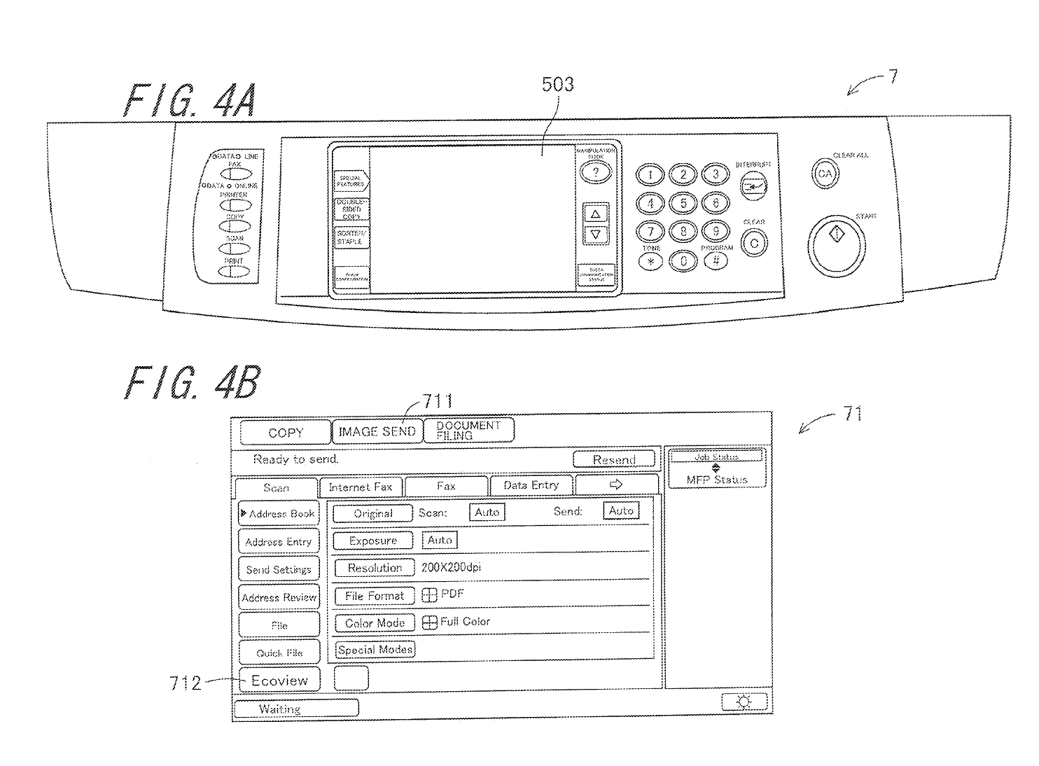

FIG. 2 is a perspective diagram showing appearance of the image forming apparatus 1. FIG. 3 is a block diagram showing a configuration of the image forming apparatus 1. FIGS. 4A and 4B are diagrams showing appearance of a manipulation panel 7. The image forming apparatus 1 is able to perform at least printing and settlement of emission rights. The settlement of emission rights means settling cost for emission rights. The image forming apparatus 1 includes a document feeder 2, an image forming apparatus main body 3, a mass sheet feeder 4, a sorter 5, a scanner 6, the manipulation panel 7 and sheet feeders 31 to 33.

The document feeder 2 sends a document to the scanner 6 one by one. The image forming apparatus main body 3 includes a control unit 501, a storage unit 502, a display unit 503, an input unit 504, an image processing unit 507, an image forming unit 508, a fixing unit 509 and a calculation unit 511. The image forming apparatus main body 3 prints information such as image information read by the scanner 6, image information acquired via a LAN 102, or image information read from a removable recording medium.

The control unit 501 is composed of, for example, a central processing unit (hereinafter, referred to as “CPU”), and executes a program that is stored in the storage unit 502 so as to control the display unit 503, the input unit 504, a connection unit 505, the image processing unit 507, the image forming unit 508, the fixing unit 509, the calculation unit 511, the document feeder 2, the mass sheet feeder 4, the sorter 5, the scanner 6, the manipulation panel 7 and the sheet feeders 31 to 33.

The storage unit 502 is configured by a storage device such as a semiconductor memory, an HDD (Hard Disk Drive) and a Blu-ray disc, for example, and stores a program executed by the CPU and information required for executing the program by the CPU. For the information stored in the storage unit 502, writing and reading are performed by the CPU.

The display unit 503 is a display apparatus provided in the manipulation panel 7, and composed of a touch panel, for example. FIG. 4A is a front view of the manipulation panel 7. The manipulation panel 7 has the display unit 503 that is provided at a central part thereof, and has a plurality of manipulation buttons that are provided on both sides of the display unit 503. The display unit 503 displays information that is instructed from the control unit 501.

The input unit 504 includes manipulation buttons provided in the manipulation panel 7 and manipulation icons provided on a display screen of the display unit 503. When the manipulation button and the manipulation icon are manipulated, the input unit 504 sends to the control unit 501 information indicating the manipulated manipulation button and manipulation icon. The information indicating the manipulation icon is information indicating a position where a user's finger is touched on the display screen, however, the control unit 501 gets a position where the manipulation icon is displayed on the display screen, and it is thus possible to recognize which manipulation icon is manipulated based on the information indicating a position where a user's finger is touched that is received from the input unit 504.

The connection unit 505 that is a sending unit is a recording device equipped with a removable recording medium such as, for example, a universal serial bus (abbreviation: “USB”) memory or a memory card, which performs writing and reading of information to/from the equipped recording medium, and a communication device for sending/receiving information to/from the server 101. The connection unit 505 sends information read from the removable recording medium and information received from the server 101, to the control unit 501, and writes in the removable recording medium or sends to the server 101 the information received from the control unit 501.

The image processing unit 507 converts image information received from a reader unit 506 or image information received from the control unit 501 into a print format which is instructed by the control unit 501 to be sent to the image forming unit 508. The print format is a format of, for example, a print size, resolution, a color or the like. The image forming unit 508 prints the image information received from the image processing unit 507 on a sheet as an image. The fixing unit 509 fixes the image printed on the sheet by the image forming unit 508.

The calculation unit 511 converts an emission amount of greenhouse gases that are emitted in order to generate electric power consumed during an operational time period when the image forming apparatus 1 is operated and electric power consumed when consumables are used in the image forming apparatus 1 to an emission amount of carbon dioxide, and sends to the server 101 actual equivalent information indicating the converted actual equivalent via the connection unit 505. The calculation unit 511 converts by image forming apparatus main body 3, optional devices that is described below and consumable item that is used in the image forming apparatus 1, as well as converting as the whole image forming apparatus 1 an emission amount of greenhouse gases to an emission amount of carbon dioxide, in which the converted value serves as the actual equivalent. The server 101 stores the actual equivalent information received from the image forming apparatus 1 in the server storage unit.

The mass sheet feeder 4 keeps sheets for printing in large quantity, and sequentially supplies the sheets to the image forming apparatus main body 3 in response to an instruction from the image forming apparatus main body 3. The sorter 5 includes a peripheral control unit 510, and sorts and discharges printed sheets. The peripheral control unit 510 sorts the sheets printed in the image forming apparatus main body 3 according to an instruction from the control unit 510 for discharging to an intended stacker among a plurality of stackers. The sorter 5 is a peripheral device, and a post-processing device such as a finisher is usable as the peripheral device in place of the sorter 5. The mass sheet feeder 4 and the peripheral device are optional devices, that is, additional devices. The finisher is a post-processing device similar to the sorter 5, and especially has functions of a Z fold of a sheet, folding an A3-size sheet in half into an A4-size sheet, and the like.

The scanner 6 includes the reader unit 506, and reads a document sent from the document feeder 2 by the reader unit 506. The reader unit 506 reads the document and sends image information showing an image of the read document to the image processing unit 507 or the control unit 501. The sheet feeders 31 to 33 are capable of keeping sheets in sizes which are different from each other, and one of the sheet feeders 31 to 33 supplies a sheet in a print size instructed by the image forming apparatus main body 3 to the image forming apparatus main body 3.

FIG. 4B is a diagram showing an example of an IMAGE SEND initial screen 71. When the image forming apparatus 1 and the server 101 are powered on and both of them become operable, the control unit 501 causes the display unit 503 to display main menu icons including an “IMAGE SEND” icon 711 as an initial screen on a display screen thereof. When a user manipulates the “IMAGE SEND” icon 711 among the main menu icons, the control unit 501 causes the display unit 503 to display the IMAGE SEND initial screen 71.

The main menu icons also appear at the top of the IMAGE SEND initial screen 71. The IMAGE SEND initial screen 71 displays a plurality of submenu icons in the left edge thereof. The control unit 501 performs control such that a selection screen 72 is displayed on the display unit 504 when an Ecoview icon 712 is manipulated out of the plurality of submenu icons.

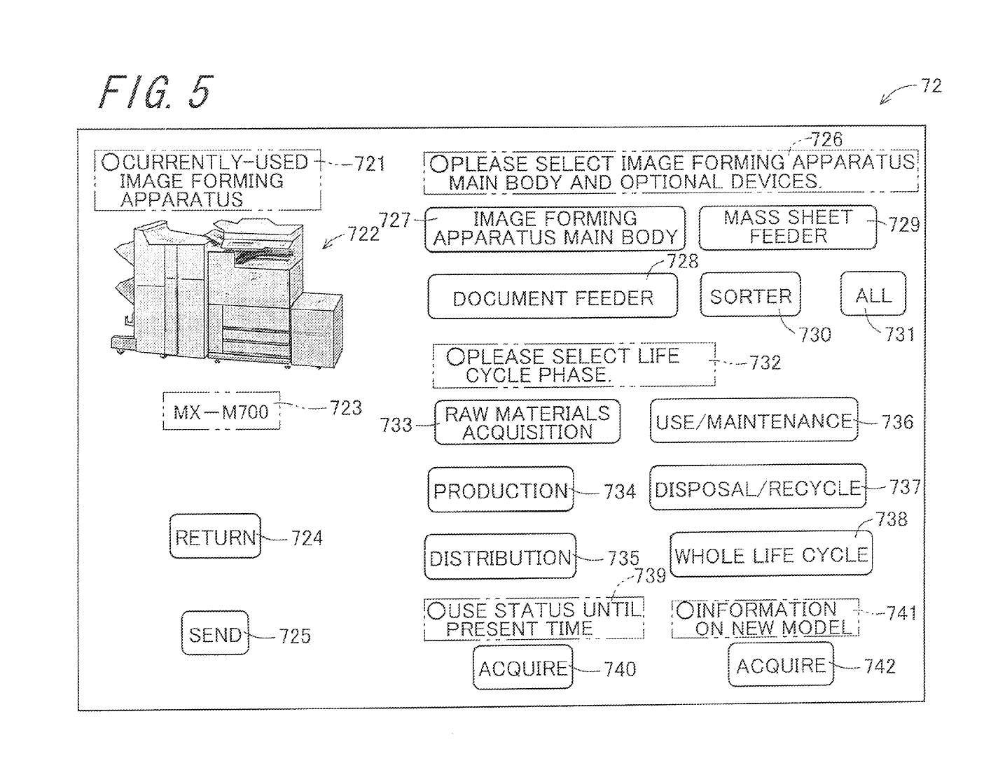

FIG. 5 is a diagram showing an example of a selected screen 72. The selected screen 72 is a screen for selecting a device and a life cycle phase for which greenhouse gas emission information is desired to be acquired to acquire greenhouse gas emission information on the selected device and life cycle phase. The greenhouse gas emission information includes acquisition equivalent information and actual equivalent information, as well as environmental information that is described below.

The selected screen 72 is provided with a target device title field 721, a target device image field 722, a target device model name field 723, a “RETURN” icon 724, a “SEND” icon 725, a device selection message field 726, an “IMAGE FORMING APPARATUS MAIN BODY” icon 727, a “DOCUMENT FEEDER” icon 728, a “MASS SHEET FEEDER” icon 729, a “SORTER” icon 730, an “ALL” icon 731, a life cycle phase selection message field 732, a “RAW MATERIALS ACQUISITION” icon 733, a “PRODUCTION” icon 734, a “DISTRIBUTION” icon 735, a “USE/MAINTENANCE” icon 736, a “DISPOSAL/RECYCLE” icon 737, a “WHOLE LIFE CYCLE” icon 738, a use status acquisition message field 739, an “ACQUIRE” icon 740, a new model information acquisition message field 741, and an “ACQUIRE” icon 742. The target device is the image forming apparatus 1 itself.

The target device title field 721 is a field for displaying a notice of the image forming apparatus 1 itself, and displayed in FIG. 5 as “∘ CURRENTLY-USED IMAGE FORMING APPARATUS”. The target device image field 722 is a field for displaying an image showing appearance of the image forming apparatus 1 itself. The target device model name field 723 is a field for displaying a model name of the image forming apparatus 1 itself, and displayed in FIG. 5 as “MX-M700”. The “RETURN” icon 724 is a manipulation icon for going back to the previous screen. The “SEND” icon 725 is a manipulation icon for sending device information indicating a device indicated by a manipulation icon selected from among manipulation icons displayed under the device selection message field 726, and life cycle phase information indicating a life cycle phase indicated by a manipulation icon selected from among manipulation icons displayed under the life cycle phase selection message field 732.

The device selection message field 726 is a field for displaying a message for prompting a user to select a device for which greenhouse gas emission information is desired to be acquired, and displayed in FIG. 5 as “∘ PLEASE SELECT IMAGE FORMING APPARATUS MAIN BODY AND OPTIONAL DEVICES.” As selectable manipulation icons, under the device selection message field 726, the “IMAGE FORMING APPARATUS MAIN BODY” icon 727, the “DOCUMENT FEEDER” icon 728, the “MASS SHEET FEEDER” icon 729, the “SORTER” icon 730, and the “ALL” icon 731 are displayed.

The “IMAGE FORMING APPARATUS MAIN BODY” icon 727 is a manipulation icon for instructing to select the image forming apparatus main body 3. The “DOCUMENT FEEDER” icon 728 is a manipulation icon for instructing to select the document feeder 2. The “MASS SHEET FEEDER” icon 729 is a manipulation icon for instructing to select the mass sheet feeder 4. The “SORTER” icon 730 is a manipulation icon for instructing to select the sorter 5. The “ALL” icon 731 is a manipulation icon for instructing to select all devices, that is, the image forming apparatus main body 3, the document feeder 2, the mass sheet feeder 4, and the sorter 5.

The life cycle phase selection message field 732 is a field for displaying a message for prompting a user to select a life cycle phase for which greenhouse gas emission information is desired to be acquired, and displayed in FIG. 5 as “∘ PLEASE SELECT LIFE CYCLE PHASE.” As selectable manipulation icons, under the life cycle phase selection message field 732, the “RAW MATERIALS ACQUISITION” icon 733, the “PRODUCTION” icon 734, the “DISTRIBUTION” icon 735, the “USE/MAINTENANCE” icon 736, the “DISPOSAL/RECYCLE” icon 737, and the “WHOLE LIFE CYCLE” icon 738 are displayed.

The life cycle phase is each of phases constituting a life cycle of the image forming apparatus 1. The life cycle phase includes a “raw materials acquisition” phase, a “production” phase, a “distribution” phase, a “use/maintenance” phase and a “disposal/recycle” phase. The “raw materials acquisition” phase is a phase for obtaining raw materials and materials required for manufacturing the image forming apparatus 1. The “production” phase is a phase for manufacturing the image forming apparatus 1. The “distribution” phase is a phase until the time the image forming apparatus 1 is shipped from a manufacturer of the image forming apparatus 1, thereafter being delivered to a user through a dealer or a leasing store. The “use/maintenance” phase is a phase in which the image forming apparatus 1 is used and maintained by a user. The “disposal/recycle” phase is a phase in which the image forming apparatus 1 off a user's hands is subject to disposal and recycling.

The life cycle phase and an amount of activity (greenhouse gas emission amount) are able to be associated with each other like the following (1) to (5):

(1) the amount of activity in the raw materials acquisition phase is a material use amount;

(2) the amount of activity in the production phase is an assembly weight and a power consumption during production;

(3) the amount of activity in the distribution phase is a transport amount (a product of a transportation distance, a loading ratio, and a truck loading amount);

(4) the amount of activity in the use/maintenance phase is a power consumption during the use; and

(5) the amount of activity in the disposal/recycle phase is a landfill weight and a recycling weight.

Additionally, the emission amount of CO₂ is calculated with use of a general formula that is defined in the carbon footprint system. The general formula is calculated by utilizing a life cycle assessment (abbreviation: LCA) method. The general formula is represented by a next formula:

emission amount of CO₂=Σ(amount of activity i×CO₂ emission basic unit),

where i indicates an amount of activity (process) from the raw materials acquisition phase to the disposal/recycle phase in the life cycle phase.

The “RAW MATERIALS ACQUISITION” icon 733 is a manipulation icon for selecting the “raw materials acquisition” phase. The “PRODUCTION” icon 734 is a manipulation icon for selecting the “production” phase. The “DISTRIBUTION” icon 735 is a manipulation icon for selecting the “distribution” phase. The “USE/MAINTENANCE” icon 736 is a manipulation icon for selecting the “use/maintenance” phase. The “DISPOSAL/RECYCLE” icon 737 is a manipulation icon for selecting the “disposal/recycle” phase. The “WHOLE LIFE CYCLE” icon 738 is a manipulation icon for selecting all phases, that is, the “raw materials acquisition” phase, the “production” phase, the “distribution” phase, the “use/maintenance” phase and the “disposal/recycle” phase.

The use status acquisition message field 739 is a field for acquiring a use status until the present time, and displayed in FIG. 5 as “∘ USE STATUS UNTIL PRESENT TIME”. Under the use status acquisition message field 739, the “ACQUIRE” icon 740 is displayed. The “ACQUIRE” icon 740 is a manipulation icon for acquiring the use status until the present time. The new model information acquisition message field 741 is a field for acquiring information on a new model, and displayed in FIG. 5 as “∘ INFORMATION ON NEW MODEL”. Under the new model information acquisition message field 741, the “ACQUIRE” icon 742 is displayed. The “ACQUIRE” icon 742 is a manipulation icon for acquiring the information on a new model.

In the embodiment, for example, when a user desires to acquire a use status of the use/maintenance life cycle phase for the image forming apparatus main body 3, the document feeder 2, the mass sheet feeder 4, and the sorter 5, the user selects the “ALL” icon 731 as well as selecting the “USE/MAINTENANCE” icon 736, and manipulates the “ACQUIRE” icon 740 under the use status acquisition message field 739, thereafter manipulating the “SEND” icon 725.

The control unit 501 requests to the server 101, in the case of being informed from the input unit 504 that the “ALL” icon 731 and the “USE/MAINTENANCE” icon 736 are selected, then the “ACQUIRE” icon 740 is manipulated and the “SEND” icon 725 is manipulated, greenhouse gas emission information in the life cycle phase of use/maintenance of the image forming apparatus main body 3, the document feeder 2, the mass sheet feeder 4 and the sorter 5 for the image forming apparatus 1 itself, via the connection unit 505.

When greenhouse gas emission information is requested from the image forming apparatus 1, the server 101 reads the greenhouse gas emission information in the life cycle phase of use/maintenance of the image forming apparatus main body 3, the document feeder 2, the mass sheet feeder 4 and the sorter 5 for the image forming apparatus 1 from among the greenhouse gas emission information that is stored in the server storage unit, and sends the read greenhouse gas emission information to the image forming apparatus 1. The control unit 501 stores, in the case of receiving the greenhouse gas emission information from the server 101 via the connection unit 505, the received greenhouse gas emission information in the storage unit 502. Then, an acquisition equivalent indicated by acquisition equivalent information included in the greenhouse gas emission information is compared to an actual equivalent indicated by actual equivalent information included in the greenhouse gas emission information, then the acquisition equivalent information and the actual equivalent information as well as a comparison result are displayed on the display unit 503 as a use status display screen 75. The control unit 501 and the connection unit 505 serve as an acquisition unit. The control unit 501 serves as a comparison unit.

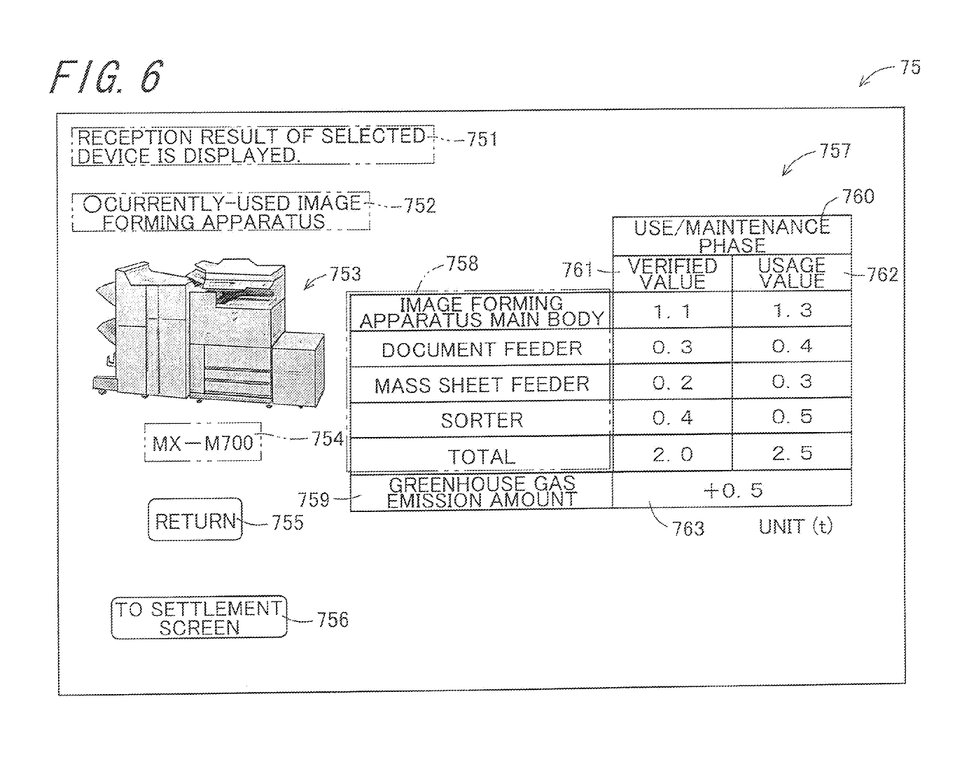

FIG. 6 is a diagram showing an example of the use status display screen 75. The use status display screen 75 is a screen for displaying a use status of emission rights, that is, an acquisition equivalent and an actual equivalent. The control unit 501 causes the display unit 503 to display, as the use status display screen 75, the acquisition equivalent indicated by acquisition equivalent information as well as the actual equivalent indicated by actual equivalent information included in the greenhouse gas emission information received from the server 101, and a comparison result between them.

The use status display screen 75 includes a use status message field 751, a target device title field 752, a target device image field 753, a target device model name field 754, a “RETURN” icon 755, a “TO SETTLEMENT SCREEN” icon 756 and a use status list field 757. The use status message field 751 is a field for displaying a message indicating that a use status received from the server 101 for a selected device is displayed, in which a message that “RECEPTION RESULT OF SELECTED DEVICE IS DISPLAYED.” is displayed in FIG. 6.

The target device title field 752, the target device image field 753, the target device model name field 754 and the “RETURN” icon 755 are the same as the target device title field 721, the target device image field 722, the target device model name field 723 and the “RETURN” icon 724, each of which description is omitted for avoiding repetition. The “TO SETTLEMENT SCREEN” icon 756 is a manipulation icon for moving to a settlement screen 76 for settling emission rights.

The use status list field 757 is a field for displaying as a list a use status, that is, an acquisition equivalent as well as an actual equivalent and a comparison result between them. The use status list field 757 includes a device item field 758, a greenhouse gas emission amount item field 759, a life cycle phase field 760, a verified value item field 761, a usage value item field 762 and a greenhouse gas emission amount field 763.

The device item field 758 is a field showing a device displaying an acquisition equivalent and an actual equivalent as items, in which five items of “IMAGE FORMING APPARATUS MAIN BODY”, “DOCUMENT FEEDER”, “MASS SHEET FEEDER”, “SORTER” and “TOTAL” are displayed in an example shown in FIG. 6. The greenhouse gas emission amount item field 759 is an item field for displaying that a value shown in the greenhouse gas emission amount field 763 indicates, as a difference, a comparison result between an acquisition equivalent and an actual equivalent for a “TOTAL” item field among items of the device item field 758.

The life cycle phase field 760 is a field for displaying that a use status displayed in the use status list field 757 indicates which use status in the life cycle phase. The verified value item field 761 is a field for displaying an item indicating a verified value for each item that is indicated in the device item field 758. The verified value is an acquisition equivalent. The verified value is a value verified by a manufacturer of the image forming apparatus 1 based on the so-called carbon footprint system, and emission rights are acquired for the verified value.

The carbon footprint system means a structure that converts an emission amount of greenhouse gases emitted through the whole life cycle from acquisition of raw materials of commodities/services to disposal/recycle to carbon dioxide (hereinafter, referred to as “CO₂”) so as to be displayed for the commodity and the service in a simple way in an easily understood manner.

There are six types of greenhouse gases including CO₂, methane (hereinafter, referred to as “CH₄”), nitrous oxide (hereinafter, referred to as “N₂O”), hydrofluorocarbon (hereinafter, referred to as “HFCs”), perfluorocarbon (hereinafter, referred to as “PFCs”) and sulfur hexafluoride (hereinafter, referred to as “SF₆”) that became targets in the Kyoto Protocol. The CO₂ equivalent is a value in which an emission amount of greenhouse gases in the whole life cycle of the image forming apparatus 1 is converted to a CO₂ emission amount.

The emission amount of CO₂ is calculated with use of a general formula that is defined in the carbon footprint system. The general formula is, as described above, represented as, for example, “emission amount of CO₂=(amount of activity i×CO₂ emission basic unit)”, where “i” is a natural number from “1” to “5” and a variable number representing each phase of the life cycle phase. For example, “amount of activity 1” is an amount of activity in the “raw materials acquisition” phase, “amount of activity 2” is an amount of activity in the “production” phase, “amount of activity 3” is an amount of activity in the “distribution” phase, “amount of activity 4” is an amount of activity in the “use/maintenance” phase and “amount of activity 5” is an amount of activity in the “disposal/recycle” phase. The “amount of activity” is one that is collected by a business operator itself that calculates, for example, power consumption in use. The “basic unit” is common data defined by an entity operating the carbon footprint system, and for example, a CO₂ emission basic unit per 1 kWh of electric power.

The usage value item field 762 is a field for displaying an item indicating a usage value for each item that is shown in the device item field 758. The usage value is an actual equivalent. The usage value is a value in which an electric energy corresponding to an amount of electric power that is used for the image forming apparatus 1 or each device by a user up to the present, or an emission amount of greenhouse gases that is equal to usage of consumables is converted to a CO₂ emission amount.

For example, assuming that the number of sheets to be copied is set to 300 thousand sheets as a life cycle of the image forming apparatus 1, when the number of copied sheets is 150 thousand sheets up to the present, a verified value is an equivalent of a CO₂ emission amount in the case of continuously copying up to 300 thousand sheets, and a usage value is an equivalent of a CO₂ emission amount for 150 thousand sheets copied up to the present.

The calculation unit 511 of the image forming apparatus 1 converts an electric energy corresponding to an amount of electric power that is used for the image forming apparatus 1 or each device to a CO₂ emission amount, and sends to the server 101 via the connection unit 505 the converted CO₂ emission amount, as a usage value, that is, an actual equivalent. The server 101 accumulates the actual equivalent received from the image forming apparatus 1 for each of the image forming apparatus 1 and a device to be stored in the server storage unit as the settled actual equivalent. The server storage unit is composed of a storage device such as, for example, a semiconductor memory, an HDD and a Blu-ray disc.

In this manner, in the embodiment, the calculation unit 511 of the image forming apparatus 1 performs conversion to a CO₂ emission amount, which is however not limited thereto, and the server 101 may perform conversion to a CO₂ emission amount. Namely, the image forming apparatus 1 sends the electric energy corresponding to the amount of electric power used for the image forming apparatus 1 or each device to the server 101 via the connection unit 505. The server 101 converts the electric energy received from the image forming apparatus 1 to a CO₂ emission amount, then accumulates the converted CO₂ emission amount per image forming apparatus 1, and stores the accumulated value in the server storage unit as an actual equivalent. In this case, the calculation unit 511 of the image forming apparatus 1 is not needed.

When the calculation unit 511 of the image forming apparatus 1 performs conversion to a CO₂ emission amount, it is not necessary to acquire an actual equivalent from the server 101 of a dealer so that it is possible to reduce communication cost. Whereas, when the server 101 of the dealer performs conversion to a CO₂ emission amount, and an actual equivalent is acquired from the server 101 of the dealer, it is not necessary to store the actual equivalent in the storage unit 502 of the image forming apparatus 1, thus having an effect that it is possible to reduce storage capacity of the storage unit 502.

When an electric energy is converted to a CO₂ emission amount, calculation is performed on the basis of a CO₂ emission amount per 1 kWh. When usage of recording sheets is converted to a CO₂ emission amount, calculation is performed on the basis of a CO₂ emission amount in a life cycle of the recording sheets. When usage of a toner cartridge is converted to a CO₂ emission amount, calculation is performed on the basis of usage of consumables used for 300 thousand recording sheets, or usage of consumables that are used per recording sheet. For example, in a case where an equivalent of a CO₂ emission amount of the usage of consumables used for 300 thousand recording sheets is 10 t, on the basis of 10 t, an equivalent of a CO₂ emission amount in the case of using the recording sheet up to 150 thousand sheets becomes 5 t.

The greenhouse gas emission amount field 763 is a field indicating a comparison result between an acquisition equivalent and an actual equivalent for the “TOTAL” item field among items of the device item field 758, that is, a difference between the acquisition equivalent and the actual equivalent, and displays a value in which the acquisition equivalent is deducted from the actual equivalent. The value displayed in the greenhouse gas emission amount field 763 is a positive value when the actual equivalent exceeds the acquisition equivalent, a negative value when the actual equivalent does not reach the acquisition equivalent, and “0” when the actual equivalent is the same as the acquisition equivalent. The “UNIT (t)” that is displayed at the bottom right of the use status list field 757 indicates that a unit of the number shown in the verified value item field 761, the usage value item field 762 and the greenhouse gas emission amount field 763 is ton (t). Although the unit of the number indicated in the verified value item field 761, the usage value item field 762 and the greenhouse gas emission amount field 763 that are shown in FIG. 6 is ton (t), a unit representing weight such as kilogram (kg) or gram (g) is usable.

On the use status display screen 75 shown in FIG. 6, the “USE/MAINTENANCE PHASE” is displayed in the life cycle phase field 760, which indicates that the use status list field 757 displays a use status in the “use/maintenance” phase. Additionally, for values of the verified value item field 761 and the usage value item field 762 concerning each item indicated by the device item field 758, the “IMAGE FORMING APPARATUS MAIN BODY” item shows “1.1” and “1.3”, the “DOCUMENT FEEDER” item shows “0.3” and “0.4”, the “MASS SHEET FEEDER” item shows “0.2” and “0.3”, the “SORTER” item shows “ ”0.4” and “0.5”, and the “TOTAL” item shows “2.0” and “2.5”. Moreover, a value of the greenhouse gas emission amount field 763 is “+0.5”, which indicates that an actual equivalent exceeds an acquisition equivalent by “0.5 (t)”.

For example, a user knows that a usage value is larger than a verified value by 0.5 t in the greenhouse gas emission amount field 763 on the use status display screen 75, and recognizes that it is necessary to perform settlement of emission rights. When the user manipulates the “TO SETTLEMENT SCREEN” icon 756 for performing settlement of emission rights, the control unit 501 causes the display unit 503 to display a settlement screen 77.

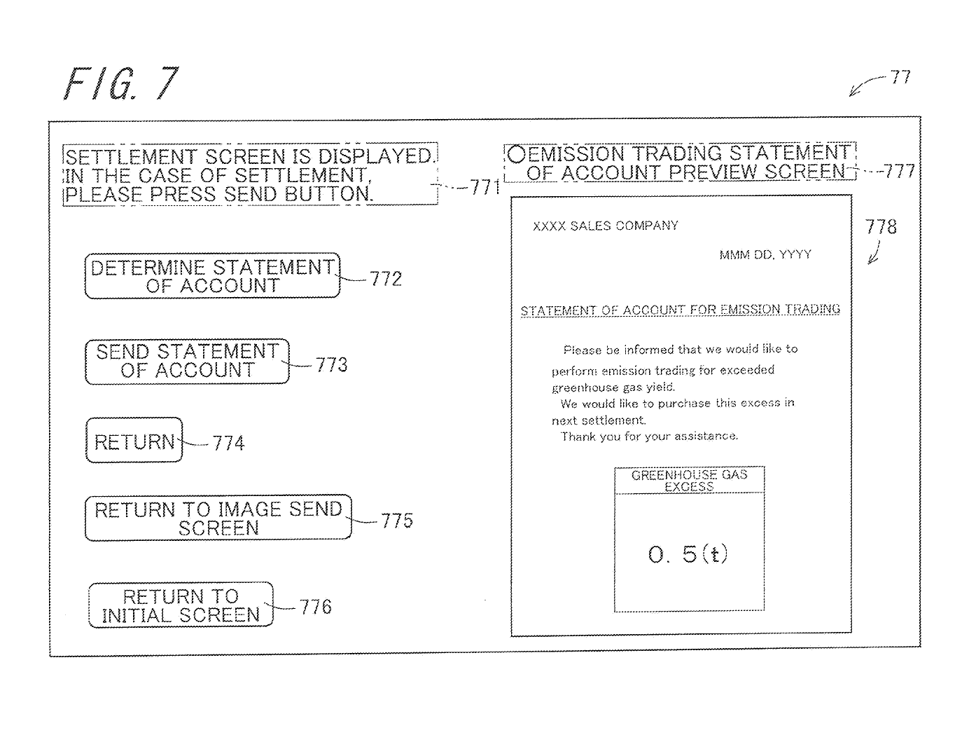

FIG. 7 is a diagram showing an example of the settlement screen 77. The settlement screen 77 is a screen for checking details of a statement of account to send the checked statement of account to the server 101. The settlement screen 77 includes a manipulation guide field 771, a “DETERMINE STATEMENT OF ACCOUNT” icon 772, a “SEND STATEMENT OF ACCOUNT” icon 773, a “RETURN” icon 774, a “RETURN TO IMAGE SEND SCREEN” icon 775, a “RETURN TO INITIAL SCREEN” icon 776, a statement of account preview title field 777, and a statement of account preview screen field 778.

The manipulation guide field 771 is a field displaying a message for guiding manipulation on the settlement screen 77, in which a message is displayed in FIG. 7 that “SETTLEMENT SCREEN IS DISPLAYED. IN THE CASE OF SETTLEMENT, PLEASE PRESS SEND BUTTON.” The “DETERMINE STATEMENT OF ACCOUNT” icon 772 is a manipulation icon for determining details of a statement of account in a preview image that is displayed on the statement of account preview screen field 778. The “SEND STATEMENT OF ACCOUNT” icon 773 is a manipulation icon for sending the determined statement of account to the server 101. The “RETURN” icon 774 is a manipulation icon for going back to the previous screen. The “RETURN TO IMAGE SEND SCREEN” icon 775 is a manipulation icon for going back to the IMAGE SEND initial screen 71. The “RETURN TO INITIAL SCREEN” icon 776 is a manipulation icon for going back to an initial screen that is first displayed in the case of being operable after power activation.

The statement of account preview title field 777 is a field displaying a title of a preview image that is displayed in the statement of account preview screen field 778, and in FIG. 7, displayed as “∘ EMISSION TRADING STATEMENT OF ACCOUNT PREVIEW SCREEN”. The statement of account preview screen field 778 is a screen area for displaying a statement of account as a preview image. In the preview image that is displayed in the statement of account preview screen field 778 shown in FIG. 7, a destination: “XXXX SALES COMPANY”, a date settled: “MMM DD, YYYY”, a subject: “STATEMENT OF ACCOUNT FOR EMISSION TRADING”, a text: “Please be informed that we would like to perform emission trading for exceeded greenhouse gas yield. We would like to purchase this excess in next settlement. Thank you for your assistance.”, and excess information of greenhouse gases: “GREENHOUSE GAS EXCESS: 0.5 (t)” are displayed.

In the embodiment, it is assumed that settlement of emission rights is performed, for example, once per month, in consideration of payment by a credit card that is commonly used, automatic withdrawal from a bank account, payment to a dealer or the like, and that “the excess is purchased in next settlement”, which is however not limited thereto, and settlement may be performed immediately, not next time.

On the use status display screen 75 shown in FIG. 6 and the settlement screen 77 shown in FIG. 7, an example is shown for performing settlement of emission rights for the whole of the image forming apparatus 1, however, it is possible to perform settlement of emission rights for each device of the image forming apparatus main body 3, the document feeder 2, the mass sheet feeder 4, or the sorter 5. For consumables such as a recording sheet and a toner cartridge, it is possible to perform settlement of emission rights for each of consumables by providing “CONSUMABLES” as a selectable manipulation icon that is displayed under the device selection message field 726 of the use status display screen 75 shown in FIG. 6.

When the control unit 501 is informed from the input unit 504 that a user manipulates the “DETERMINE STATEMENT OF ACCOUNT” icon 772 and manipulates the “SEND STATEMENT OF ACCOUNT” icon 773, the control unit 501 prepares a statement of account, and sends the prepared statement of account to the server 101 via the connection unit 505. The server 101 prepares, in the case of receiving the statement of account, an emission trading order sheet, and sends the prepared emission trading order sheet to the image forming apparatus 1. The emission trading order sheet is a receipt document for a statement of account indicating that the statement of account is received. The control unit 501 performs, in the case of receiving the emission trading order sheet from the server 101 via the connection unit 505, display of the received emission trading order sheet as an emission trading order sheet screen 80. The control unit 501 and the connection unit 505 serve as a settlement unit.

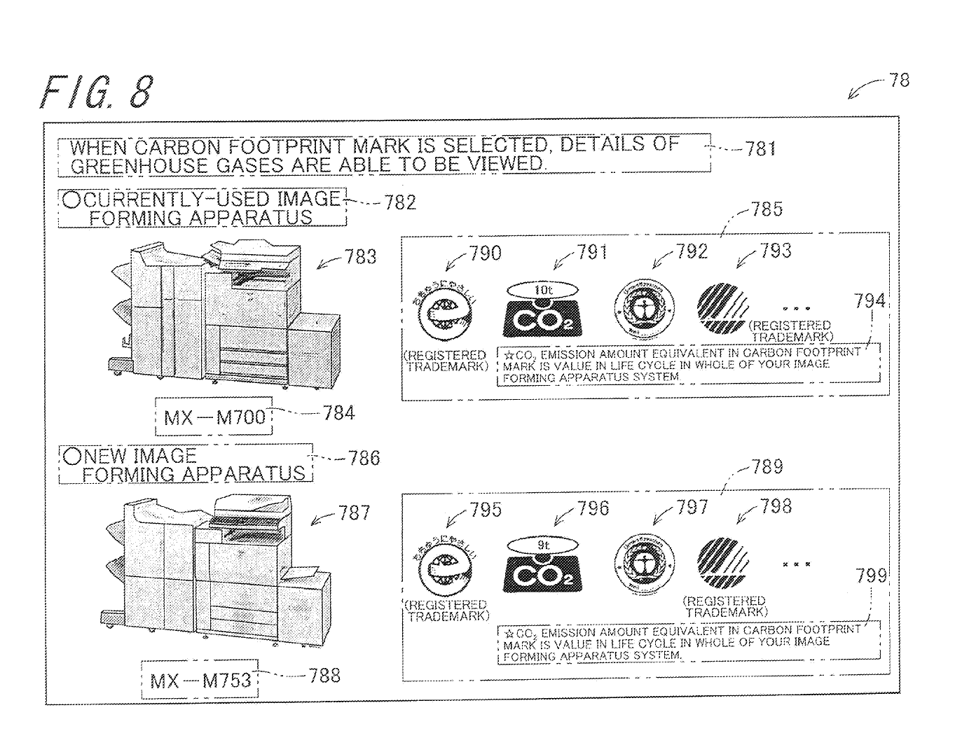

FIG. 8 is a diagram showing an example of a new product display screen 78. The new product display screen 78 is a screen for displaying information on a new model of an image forming apparatus which is developed and released after the image forming apparatus 1 that is currently used by a user was developed. On the selected screen 72 shown in FIG. 5, when the control unit 501 is informed from the input unit 504 that the user manipulates the “ACQUIRE” icon 742, the control unit 501 causes the display unit 503 to display the new product display screen 78.

The new product display screen 78 includes a manipulation guide field 781, a target device title field 782, a target device image field 783, a target device model name field 784, a target device environmental mark thumbnail display field 785, a new device title field 786, a new device image field 787, a new device model name field 788 and a new product environmental mark thumbnail display field 789. The manipulation guide field 781 is a field for displaying a message for guiding manipulation on the new product display screen 78, in which a message is displayed in FIG. 8 that “WHEN CARBON FOOTPRINT MARK IS SELECTED, DETAILS OF GREENHOUSE GASES ARE ABLE TO BE VIEWED.”

The target device title field 782, the target device image field 783 and the target device model name field 784 are the same as the target device title field 721, the target device image field 722 and the target device model name field 723 shown in FIG. 5, each of which description is omitted for avoiding repetition. The target device environmental mark thumbnail display field 785 is a field for displaying in a thumbnail form an environmental mark acquired by a target device and an environmental mark which is certified or authorized for a target device. In the target device environmental mark thumbnail display field 785, for example, environmental marks such as an Eco Mark (registered trademark) 790, a carbon footprint mark 791, a Blue Angel Mark 792 and a Nordic Swan Mark (registered trademark) 793 are displayed.

The Eco Mark (registered trademark) 790 is a mark indicating that accreditation is received from Japan Environment Association. The carbon footprint mark 791 is a mark indicating that verification has been conducted by the carbon footprint system. In the carbon footprint mark 791, a character “CO₂” and a CO₂ equivalent (t) are displayed. In the carbon footprint mark 791 shown in FIG. 8, “10 t” is displayed as the CO₂ equivalent.

In the carbon footprint mark 791, a supplementary explanation 794 is described concerning the CO₂ equivalent displayed in the carbon footprint mark 791. In the supplementary explanation 794 shown in FIG. 8, the supplementary explanation is displayed that “* CO₂ EMISSION AMOUNT EQUIVALENT IN CARBON FOOTPRINT MARK IS VALUE IN LIFE CYCLE IN WHOLE OF YOUR IMAGE FORMING APPARATUS SYSTEM.”

The Blue Angel Mark 792 is an eco mark of Germany, and a mark indicating that certification of the Blue Angel system is acquired. The Nordic Swan Mark (registered trademark) 793 is a mark indicating that certification of the eco label system officially authorized by Nordic countries is acquired.

The new device title field 786 is a field for displaying a notice of a new image forming apparatus, and displayed in FIG. 8 as “∘ NEW IMAGE FORMING APPARATUS”. The new device image field 787 is a field for displaying an image showing appearance of a new image forming apparatus. The new device model name field 788 is a field for displaying a model name of the new image forming apparatus, and displayed in FIG. 8 as “MX-M753”.

The new product environmental mark thumbnail display field 789 is a field for displaying in a thumbnail form an environmental mark acquired by a new image forming apparatus and an environmental mark which is certified or authorized for a new image forming apparatus. In the new product environmental mark thumbnail display field 789, for example, as with the target device environmental mark thumbnail display field 785, environmental marks such as an Eco Mark (registered trademark) 795, a carbon footprint mark 796, a Blue Angel Mark 797 and a Nordic Swan Mark (registered trademark) 798, as well as a supplementary explanation 799 are displayed. The Eco Mark (registered trademark) 795, the carbon footprint mark 796, the Blue Angel Mark 797, the Nordic Swan Mark (registered trademark) 798 and the supplementary explanation 799 are the same as the Eco Mark (registered trademark) 790, the carbon footprint mark 791, the Blue Angel Mark 792, the Nordic Swan Mark (registered trademark) 793 and the supplementary explanation 794, each of which description is omitted for avoiding repetition.

In the carbon footprint mark 796 shown in FIG. 8, “9 t” is displayed as a CO₂ equivalent. The CO₂ equivalent indicated in the carbon footprint mark 796, that is, the CO₂ equivalent “9 t” of the new product is a value smaller than the CO₂ equivalent indicated in the carbon footprint mark 791, that is, the CO₂ equivalent “10 t” of the image forming apparatus 1 that is currently used by a user. Namely, a larger emission amount of greenhouse gases is reduced in the new product, and the new product thus has a less emission amount, so that it is possible to encourage a user to purchase the new image forming apparatus.

Additionally, environmental marks are displayed in the target device environmental mark thumbnail display field 785 and the new product environmental mark thumbnail display field 789 so that a user is able to select and purchase the image forming apparatus 1 satisfying more environmental standards.

In this manner, since it is possible to acknowledge a verified value of an emission amount of greenhouse gases in a life cycle of a new product with reference to the carbon footprint mark 796, thus making it possible to purchase or lease an image forming apparatus with a less emission amount of greenhouse gases. Its sale is also promoted at a dealer or a leasing store, thus getting a benefit of improvement of sales, and it is eventually possible to contribute to prevention of global warming.

By following a guidance that is displayed in the manipulation guide field 781, for example, the carbon footprint mark 791 is manipulated, thereby going back to the selected screen 72 shown in FIG. 5, and a device and a life cycle phase are selected on the selected screen 72 so that it is possible to display a verified value on the use status display screen 75 shown in FIG. 6. Further, when the carbon footprint mark 796 is manipulated, a not-shown selected screen concerning a new product is displayed as with the selected screen 72 shown in FIG. 5, and a device and a life cycle phase are selected on the selected screen, thereby displaying a use status display screen concerning the new product (not shown) as with the use status display screen 75 shown in FIG. 6, then a verified value is displayed on the screen. However, since the new product has been unused yet, the “TO SETTLEMENT SCREEN” icon 756 and the usage value item field 762 are not displayed.

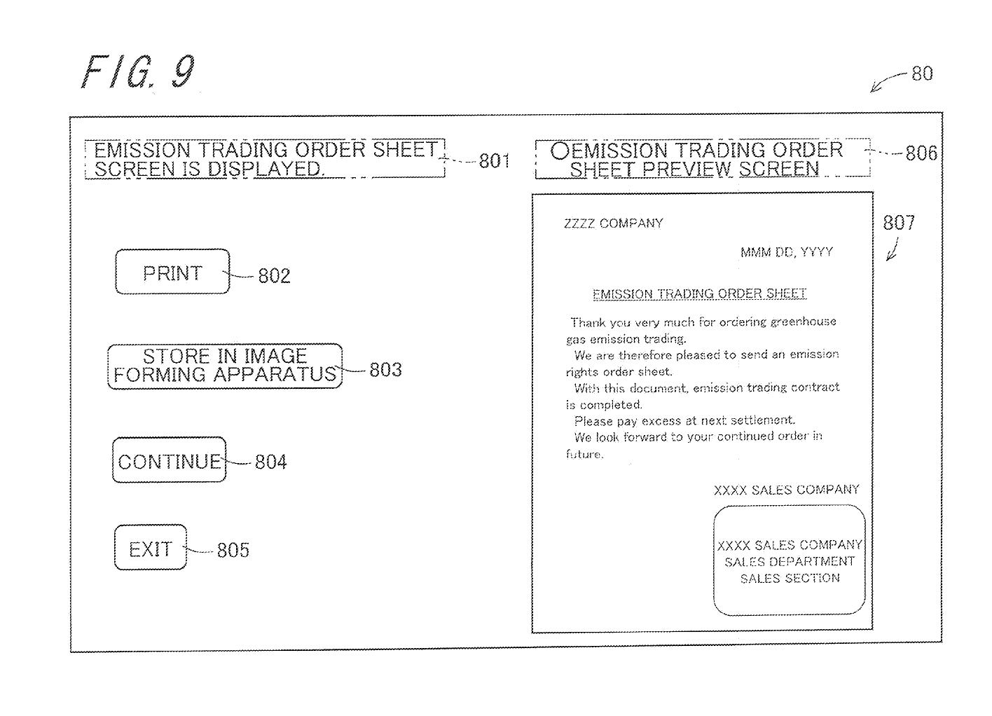

FIG. 9 is a diagram showing an example of the emission trading order sheet screen 80. The emission trading order sheet screen 80 is a screen for confirming details of the emission trading order sheet received from the server 101. The emission trading order sheet screen 80 includes an order sheet message field 801, a “PRINT” icon 802, a “STORE IN IMAGE FORMING APPARATUS” icon 803, a “CONTINUE” icon 804, an “EXIT” icon 805, an order sheet preview title field 806 and an order sheet preview screen field 807.

The order sheet message field 801 is a field for receiving an emission trading order sheet from the server 101 to display a message indicating that the received emission trading order sheet is displayed, in which a message is displayed in FIG. 9 that “EMISSION TRADING ORDER SHEET SCREEN IS DISPLAYED.” The “PRINT” icon 802 is a manipulation icon for printing the received emission trading order sheet. The “STORE IN IMAGE FORMING APPARATUS” icon 803 is a manipulation icon for storing the received emission trading order sheet in the storage unit 502. The “CONTINUE” icon 804 is a manipulation icon for continuing settlement of emission rights. The “EXIT” icon 805 is a manipulation icon for terminating settlement process of emission rights.

The order sheet preview title field 806 is a field for displaying a title of a preview image that is displayed in the order sheet preview screen field 807, and displayed in FIG. 9 as “∘ EMISSION TRADING ORDER SHEET PREVIEW SCREEN”. The order sheet preview screen field 807 is a screen area for displaying the emission trading order sheet as a preview image. In the preview image that is displayed in the order sheet preview screen field 807 shown in FIG. 9, a destination: “ZZZZ COMPANY”, a date ordered: “MMM DD, YYYY”, a subject: “EMISSION TRADING ORDER SHEET”, a text: “Thank you very much for ordering greenhouse gas emission trading. We are therefore pleased to send an emission rights order sheet. With this document, emission trading contract is completed. Please pay excess at next settlement. We look forward to your continued order in future.”, and a name of an ordered party: “XXXX sales company (XXXX SALES COMPANY, SALES DEPARTMENT, SALES SECTION)” are displayed.

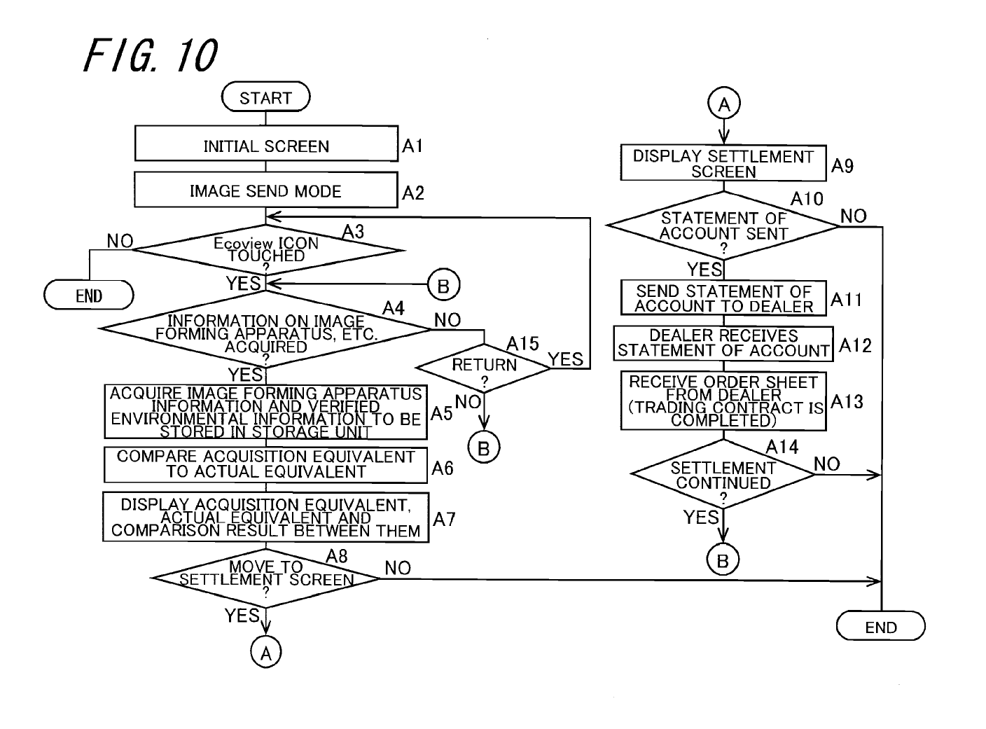

FIG. 10 is a flowchart showing a processing sequence of emission rights settlement process that is executed in the emission trading system 100. When the image forming apparatus 1 and the server 101 are powered on and both of them are operable, the process proceeds to step A1.

In step A1, the control unit 501 causes the display unit 503 to display an initial screen. In the initial screen, the main menu icons including the “IMAGE SEND” icon 711 are displayed. When a user manipulates the “IMAGE SEND” icon 711, the process proceeds to step A2. In step A2, the control unit 501 sets a mode of the image forming apparatus 1 to an “IMAGE SEND” mode and causes the display unit 503 to display the IMAGE SEND initial screen 71 as shown in FIG. 4B.

In step A3, the control unit 501 determines whether or not an Ecoview icon is touched. When the “Ecoview” icon 712 is manipulated, it is determined that the Ecoview icon is touched, then the process proceeds to step A4, and when the “Ecoview” icon 712 is not manipulated, it is determined that the Ecoview icon is not touched, then the process is terminated.

In step A4, the control unit 501 determines whether or not to acquire information of the image forming apparatus 1 and the like, that is, greenhouse gas emission rights information. Specifically, the control unit 501 first causes the display unit 503 to display the selected screen 72 shown in FIG. 5. When a device and a life cycle phase for which greenhouse gas emission rights information is desired to be acquired are selected on the selected screen 72, then the “ACQUIRE” icon 740 is manipulated, thereafter manipulating the “SEND” icon 725, the control unit 501 determines to acquire the information of the image forming apparatus 1 and the like, and the process proceeds to step A5. When the device and the life cycle phase for which greenhouse gas emission rights information is desired to be acquired are not selected and the “ACQUIRE” icon 740 is not manipulated on the selected screen 72, or the “SEND” icon 725 is not manipulated, the information of the image forming apparatus 1 and the like are determined not to be acquired, and the process proceeds to step A15.

In step A5 that is an acquisition step, the control unit 501 acquires image forming apparatus information and verified environmental information, and stores, that is, memorizes the acquired image forming apparatus information and verified environmental information in the storage unit 502. The image forming apparatus information and the verified environmental information are greenhouse gas emission information. The image forming apparatus information means actual equivalent information and acquisition equivalent information, and the verified environmental information means an environmental mark.

Specifically, in step A5, the control unit 501 requests greenhouse gas emission information of the device and the life cycle phase selected on the selected screen 72 to the server 101 via the connection unit 505. The server 101 reads, when the greenhouse gas emission information of the device and the life cycle phase selected in the image forming apparatus 1 are requested from the image forming apparatus 1, the greenhouse gas emission information of the device and the life cycle phase selected in the image forming apparatus 1 from among greenhouse gas emission information that is stored in the server storage unit, and sends the read greenhouse gas emission information to the image forming apparatus 1. The control unit 501 stores, in the case of receiving the greenhouse gas emission information via the connection unit 505, the received greenhouse gas emission information in the storage unit 502.

In step A6 that is a comparison step, the control unit 501 compares an acquisition equivalent to an actual equivalent. Namely, the control unit 501 reads from the storage unit 502 the acquisition equivalent information and the actual equivalent information that are included in the greenhouse gas emission information, and compares an acquisition equivalent indicated by the read acquisition equivalent information to an actual equivalent indicated by the read actual equivalent information.

In step A7 that is a displaying step, the control unit 501 causes the display unit 503 to display the acquisition equivalent information and the actual equivalent information that are read from the storage unit 502, as well as a comparison result in step A6 as the use status display screen 75 shown in FIG. 6.

In step A8, the control unit 501 determines whether or not to move to the settlement screen 77. Specifically, when a user manipulates the “TO SETTLEMENT SCREEN” icon 756 on the use status display screen 75, the control unit 501 determines to move to the settlement screen 77, then the process proceeds to step A9. When the user does not manipulate the “TO SETTLEMENT SCREEN” icon 756 on the use status display screen 75 and manipulates the “RETURN” icon 755, the control unit 501 determines not to move to the settlement screen 77, and terminates the process.

In step A9, the control unit 501 performs display of the settlement screen 77. That is, the control unit 501 causes the display unit 503 to display the settlement screen 77 shown in FIG. 7. In step A10, the control unit 501 determines whether or not to send a statement of account. Specifically, when the control unit 501 is informed from the input unit 504 that the “DETERMINE STATEMENT OF ACCOUNT” icon 772 is manipulated and the “SEND STATEMENT OF ACCOUNT” icon 773 is thereafter manipulated on the settlement screen 77, the control unit 501 determines to send the statement of account, and the process proceeds to step A11. When a user does not manipulate the “DETERMINE STATEMENT OF ACCOUNT” icon 772 and the “SEND STATEMENT OF ACCOUNT” icon 773 on the settlement screen 77 and manipulates the “RETURN” icon 774, the “RETURN TO IMAGE SEND SCREEN” icon 775 or the “RETURN TO INITIAL SCREEN” icon 776, the control unit 501 determines not to send the statement of account, and terminates the process.

In step A11, the control unit 501 sends the statement of account to a dealer. Specifically, the control unit 501 sends the statement of account displayed as a preview image on the statement of account preview screen field 778 of the settlement screen 77 to the server 101 via the connection unit 505. In step A12, the dealer receives the statement of account. Namely, the server 101 provided at the dealer receives the statement of account sent from the image forming apparatus 1. The server 101 generates an emission trading order sheet in response to the received statement of account, and sends the generated emission trading order sheet to the image forming apparatus 1. Step A8 to step A12 serve as a settlement step.

In step A13, the control unit 501 receives an order sheet from a dealer, thereby completing the trading contract. Namely, the control unit 501 receives an order sheet, that is, an emission trading order sheet from the server 101 of the dealer via the connection unit 505, and causes the display unit 503 to display the emission trading order sheet screen 80. Receipt of the emission trading order sheet means that the emission trading contract is completed.

In step A14, the control unit 501 determines whether or not to continue settlement. The control unit 501 determines to continue settlement in the case of being informed from the input unit 504 that the “CONTINUE” icon 804 is manipulated on the emission trading order sheet screen 80, and the process goes back to step A4. In the case of being informed from the input unit 504 that the “CONTINUE” icon 804 is not manipulated and the “EXIT” icon 805 is manipulated on the emission trading order sheet screen 80, the settlement is determined not to be continued and the process is terminated.

In step A15, the control unit 501 determines whether or not to return. The control unit 501 determines to return when the “RETURN” icon 724 is manipulated, and then the process goes back to step A3, and determines not to return when the “RETURN” icon 724 is not manipulated, and then the process goes back to step A4.

In this manner, in the case of forming an image, the control unit 501 and the connection unit 505 acquire acquisition equivalent information indicating an acquisition equivalent in which an emission amount of greenhouse gases which are emitted by operation of the image forming apparatus 1, for which greenhouse gases emission rights are acquired, is converted to an emission amount of carbon dioxide, and actual equivalent information indicating an actual equivalent in which an emission amount of greenhouse gases which are emitted by operation of the image forming apparatus 1 is converted to an emission amount of carbon dioxide, from the server 101 that stores the acquisition equivalent information and the actual equivalent information and settles cost of emission rights. The control unit 501 compares the acquisition equivalent indicated by the acquisition equivalent information that is acquired by the control unit 501 and the connection unit 505 to the actual equivalent indicated by the actual equivalent information that is acquired by the control unit 501 and the connection unit 505. The display unit 503 displays a comparison result of comparison performed by the control unit 501. Then, when the comparison result of comparison performed by the control unit 501 indicates that the actual equivalent is larger than the acquisition equivalent, the control unit 501 and the connection unit 505 are able to request the server 101 to settle cost for the emission rights of greenhouse gases that are equal to a carbon dioxide equivalent which is a difference between the acquisition equivalent and the actual equivalent.

Therefore, it is possible for a user to settle emission rights that are equal to the exceeded emission amount even when greenhouse gases that exceed an emission amount of greenhouse gases for which emission rights are granted are emitted, thus there is no need to purchase emission rights of greenhouse gases at the time of purchase of the image forming apparatus 1 or the like, so that it is possible to purchase or lease a less expensive image forming apparatus or the like for which emission rights are not granted. Additionally, the user is able to settle the emission rights according to a use status so that it is possible to reduce a usage maintenance cost which is expense required for using and maintaining the image forming apparatus 1 or the like. Further, the user is able to suppress emission of greenhouse gases by reducing a use frequency without performing replacement or new leasing of the image forming apparatus 1 or the like that is still usable. Namely, even for consumables, the image forming apparatus 1 and optional devices for which emission rights are not granted, it is possible to promote greenhouse gas emission reduction. Moreover, the user recognizes an equivalent that is converted to carbon dioxide of greenhouse gases emitted in the image forming apparatus 1 or the like which is used by the user each time emission rights are settled, thus making it possible to promote replacement with or leasing to a model with less generation of greenhouse gases in a case where the image forming apparatus 1 or the like which is used by the user is a model which generates a large amount of greenhouse gases, and eventually contribute to prevention of global warming, so that receiving an order of the image forming apparatus 1 or the like is facilitated, thereby making it possible to also attempt increase of sales at a dealer or a leasing store.

Further, the emission rights are acquired by a manufacturer or a dealer of each image forming apparatus 1. Therefore, a user does not need to acquire the emission rights in a straightforward manner.

Further, the connection unit 505 sends an electric energy of electric power consumed for operation of the image forming apparatus 1, to the server 101. Then, the actual equivalent is a value in which the server 101 converts the electric energy sent by the connection unit 505 to an emission amount of carbon dioxide. Therefore, it is not necessary to convert to an emission amount of carbon dioxide in the image forming apparatus 1.

Further, the image forming apparatus main body 3 for forming an image and one or more optional devices that are added to the image forming apparatus main body 3 are included. Then, the emission rights include emission rights for each of the image forming apparatus main body 3 and the optional devices, and the whole image forming apparatus 1. Therefore, it is possible to perform settlement of emission rights for each of the image forming apparatus main body 3 and the optional devices, and the whole image forming apparatus 1.

Further, the display unit 503 is composed of a touch panel. Therefore, the touch panel integrally provided with a manipulation unit is used as the display unit 503 of the image forming apparatus 1 so that it is possible for a user to easily acquire directly from the server 101 and display information to select information. Additionally, it is possible to easily use emission trading service provided by a manufacturer, a dealer, a representative or a leasing store of the image forming apparatus 1 or the like.

Further, the server 101 is connected by a communication line including a network. Therefore, it is possible to easily use emission trading service even with the image forming apparatus 1 that is installed in a remote location that is far from the server 101, so that it is possible to easily get emission trading service that is convenient for a user.

Further, in a greenhouse gas emission trading system including the image forming apparatus 1 for forming an image, and the server 101 that stores acquisition equivalent information and actual equivalent information, and settles cost of emission rights, the acquisition equivalent information indicating an acquisition equivalent in which an emission amount of greenhouse gases which are emitted by operation of the image forming apparatus 1, for which greenhouse gases emission rights are acquired, is converted to an emission amount of carbon dioxide, and the actual equivalent information indicating an actual equivalent in which an emission amount of greenhouse gases which are emitted by operation of the image forming apparatus 1 is converted to an emission amount of carbon dioxide, for performing emission trading of greenhouse gases, the image forming apparatus 1 includes the control unit 501, the display unit 503 and the connection unit 505. The control unit 501 and the connection unit 505, which serve as the acquisition unit, acquire the acquisition equivalent information and the actual equivalent information from the server 101. The control unit 501, which serves as the comparison unit, compares an acquisition equivalent indicated by the acquisition equivalent information that is acquired by the control unit 501 and the connection unit 505 (i.e., the acquisition unit) to an actual equivalent indicated by the actual equivalent information that is acquired by the control unit 501 and the connection unit 505 (i.e., the acquisition unit). The display unit 503 displays a comparison result of comparison performed by the control unit 501 (i.e., the comparison unit). Then, the control unit 501 and the connection unit 505, which serve as the settlement unit, are able to request the server 101 to settle cost for emission rights of greenhouse gases that are equal to a carbon dioxide equivalent which is a difference between the actual equivalent and the acquisition equivalent when the comparison result of comparison performed by the control unit 501 (i.e., the comparison unit) shows that the actual equivalent is larger than the acquisition equivalent.

Therefore, it is possible for a user to settle emission rights that are equal to the exceeded emission amount even when greenhouse gases that exceed an emission amount of greenhouse gases for which emission rights are granted are emitted, thus there is no need to purchase emission rights of greenhouse gases at the time of purchase of the image forming apparatus 1 or the like, so that it is possible to purchase or lease a less expensive image forming apparatus or the like for which emission rights are not granted. Additionally, the user is able to settle the emission rights according to a use status so that it is possible to reduce a usage maintenance cost which is expense required for using and maintaining the image forming apparatus 1 or the like. Further, the user is able to suppress emission of greenhouse gases by reducing a use frequency without performing replacement or new leasing of the image forming apparatus 1 or the like that is still usable. Namely, even for consumables, the image forming apparatus 1 and optional devices for which emission rights are not granted, it is possible to promote greenhouse gas emission reduction. Moreover, the user recognizes an equivalent that is converted to carbon dioxide of greenhouse gases emitted in the image forming apparatus 1 or the like which is used by the user each time emission rights are settled, thus making it possible to promote replacement with or leasing to a model with less generation of greenhouse gases in a case where the image forming apparatus 1 or the like which is used by the user is a model which generates a large amount of greenhouse gases, and eventually contribute to prevention of global warming, so that receiving an order of the image forming apparatus 1 or the like is facilitated, thereby making it possible to also attempt increase of sales at a dealer or a leasing store.

Further, in the greenhouse gas emission trading system including the image forming apparatus 1 that includes the display unit 503 and forms an image, and the server 101 that stores acquisition equivalent information and actual equivalent information, and settles cost of emission rights, the acquisition equivalent information indicating an acquisition equivalent in which an emission amount of greenhouse gases which are emitted by operation of the image forming apparatus 1, for which greenhouse gases emission rights are acquired, is converted to an emission amount of carbon dioxide, and the actual equivalent information indicating an actual equivalent in which an emission amount of greenhouse gases which are emitted by operation of the image forming apparatus 1 is converted to an emission amount of carbon dioxide, for performing emission trading of greenhouse gases, in the flowchart shown in FIG. 10, in step A5, the acquisition equivalent information and the actual equivalent information are acquired from the server 101. In step A6, an acquisition equivalent indicated by the acquisition equivalent information that is acquired in step A5 is compared to an actual equivalent indicated by the actual equivalent information that is acquired in step A5. In step A7, a comparison result of comparison performed in step A6 is displayed on the display unit 503. Then, in step A8 to step A12, it is possible to request the server 101 to settle cost for emission rights of greenhouse gases that are equal to a carbon dioxide equivalent which is a difference between the actual equivalent and the acquisition equivalent when the comparison result of comparison performed in step A6 shows that the actual equivalent is larger than the acquisition equivalent.

Therefore, it is possible for a user to settle emission rights that are equal to the exceeded emission amount even when greenhouse gases that exceed an emission amount of greenhouse gases for which emission rights are granted are emitted, thus there is no need to purchase emission rights of greenhouse gases at the time of purchase of the image forming apparatus 1 or the like, so that it is possible to purchase or lease a less expensive image forming apparatus or the like for which emission rights are not granted. Additionally, the user is able to settle the emission rights according to a use status so that it is possible to reduce a usage maintenance cost which is expense required for using and maintaining the image forming apparatus 1 or the like. Further, the user is able to suppress emission of greenhouse gases by reducing a use frequency without performing replacement or new leasing of the image forming apparatus 1 or the like that is still usable. Namely, even for consumables, the image forming apparatus 1 and optional devices for which emission rights are not granted, it is possible to promote greenhouse gas emission reduction. Moreover, the user recognizes an equivalent that is converted to carbon dioxide of greenhouse gases emitted in the image forming apparatus 1 or the like which is used by the user each time emission rights are settled, thus making it possible to promote replacement with or leasing to a model with less generation of greenhouse gases in a case where the image forming apparatus 1 or the like which is used by the user is a model which generates a large amount of greenhouse gases, and eventually contribute to prevention of global warming, so that receiving an order of the image forming apparatus 1 or the like is facilitated, thereby making it possible to also attempt increase of sales at a dealer or a leasing store.

Hereinafter, description will be given for a configuration in which a large display unit as another display unit other than the display unit 503 is included according to another embodiment.

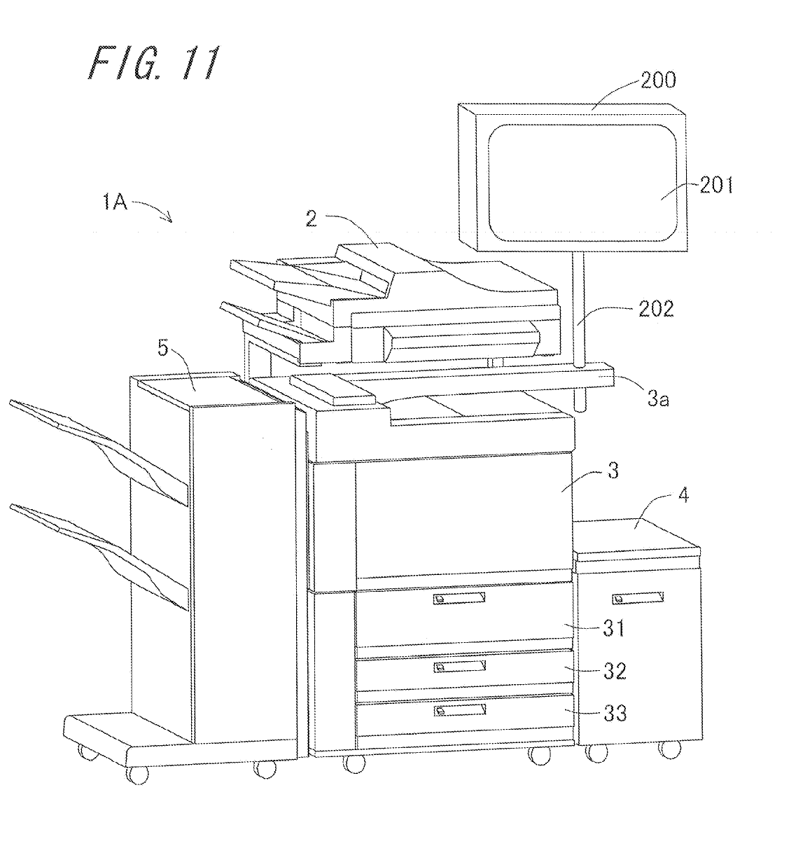

FIG. 11 is a perspective diagram showing appearance of an image forming apparatus 1A provided with a large display unit 200. The display unit 503 is provided in the manipulation panel 7 as a display unit with a relatively-small screen for including a function as an input unit by a touch panel, and is installed so that a display direction orthogonal to a display screen is parallel to a vertical direction or so as to form an angle of approximately 5° to 10° with respect to the vertical direction. This is because the display unit 503 is assumed to have a display screen that is viewed by a user who manipulates the manipulation panel 7.

The large display unit 200 provided in the image forming apparatus 1A has a rotary shaft 202 extending along the vertical direction that is supported by a supporting section 3a which projects in a horizontal direction from a side surface of the image forming apparatus main body 3, and the large display unit 200 is installed at a top end part of the rotary shaft 202 so as to rotatable around an axis of the rotary shaft 202.

A display surface 201 of the large display unit 200 is provided so as to be approximately parallel to the vertical direction, that is, so that a display direction is approximately parallel to the horizontal direction. Such the large display unit 200 is installed so that the screen is easily viewed from not only the user who manipulates the image forming apparatus 1A but also people around the image forming apparatus 1A.

The large display unit 200 is electrically connected to the control unit 501 as with the display unit 503, and displays a screen by an instruction of the control unit 501. The screen that is displayed on the large display unit 200 may be exactly the same as that of the display unit 503 or a part thereof. For example, the use status display screen 75 shown in FIG. 6 and the new product display screen 78 shown in FIG. 8 are displayed on the display unit 503 as well as being displayed also on the large display unit 200.

The use status display screen 75 is displayed on the large display unit 200 so that not only the user but also surrounding people are able to view a difference in a comparison result between the acquisition equivalent and the actual equivalent, and the new product display screen 78 is displayed on the large display unit 200 so that not only the user but also the surrounding people figure out that a new product has a larger amount of greenhouse gas emission reduction so that the new product has less amount of greenhouse gas emission, thereby making it possible to encourage to purchase a new image forming apparatus.

Since the carbon footprint mark 796 is displayed on the large display unit 200 so that it is possible to figure out a verified value of an emission amount of greenhouse gases in a life cycle of the new product, the image forming apparatus 1A is installed in the front of a store, thereby appealing to a client or the like who visits the store other than the user, which leads to promotion of the image forming apparatus, thereby gaining a benefit of sales increase, so that it is eventually possible to further contribute to prevention of global warming.

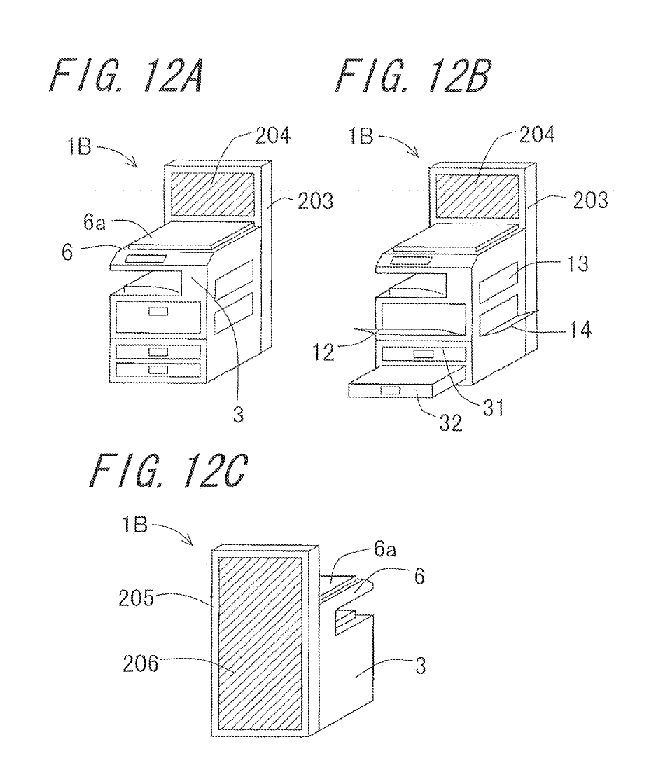

FIGS. 12A to 12C are perspective diagrams showing appearance of an image forming apparatus 1B provided with large display units 203 and 205. FIGS. 12A and 12B are perspective diagrams viewing from a front side, and FIG. 12C is a perspective diagram viewing from a rear side.

The image forming apparatus 1B is not provided with the document feeder 2, and is provided with the scanner 6 having a document pressing cover 6a. A configuration is provided as a front access type such that a front door 12 is provided on a front face side of a housing of the image forming apparatus main body 3, and two side doors 13 and 14 are provided so as to be one above the other also on a right surface side of the housing. It is possible to perform maintenance such as toner replenishment by opening the front door 12. Additionally, in the case of removing jammed recording sheets from a paper conveyance path, the side doors 13 and 14 are configured to be opened as appropriate.

In the embodiment, the large display units 203 and 205 are provided on a back side of the image forming apparatus main body 3. The large display unit 203 includes a display screen 204 so that a display direction is a front side, and the large display unit 205 includes a display screen 206 so that a display direction is a rear side.

In the embodiment, a back face of the image forming apparatus main body 3 is used as a supporting surface for supporting the large display units 203 and 205. This makes it possible to substantively accommodate the image forming apparatus main body 3 and two large devices such as the large display units 203 and 205, as their installation space, in installation space of the image forming apparatus main body 3. Further, connecting wiring of the image forming apparatus main body 3 and the large display units 203 and 205 are also not exposed outside, thus having good appearance, and a problem of catching on the connecting wiring does not occur. This makes it possible to install the image forming apparatus in a conventionally-installed place nearly as it is even in a store having small space.

Further, the large display units 203 and 205 share the housing, and are arranged so that an upper part of the housing projects upward from the image forming apparatus main body 3. The display screen 204 of the large display unit 203 is arranged on a front side of a projecting part of the housing, and the display screen 206 of the large display unit 205 is provided on almost the entire back face side of the housing.

Both of the large display units 203 and 205 are electrically connected to the control unit 501 as with the above-described large display unit 200, and display a screen by an instruction of the control unit 501. The screen that is displayed on the large display unit 200 may be exactly the same as that of the display unit 503 or a part thereof. For example, the use status display screen 75 shown in FIG. 6 and the new product display screen 78 shown in FIG. 8 are displayed on the display unit 503 as well as being displayed also on the large display units 203 and 205.

Description will be given for display apparatuses 300 and 400 according to still another embodiment.

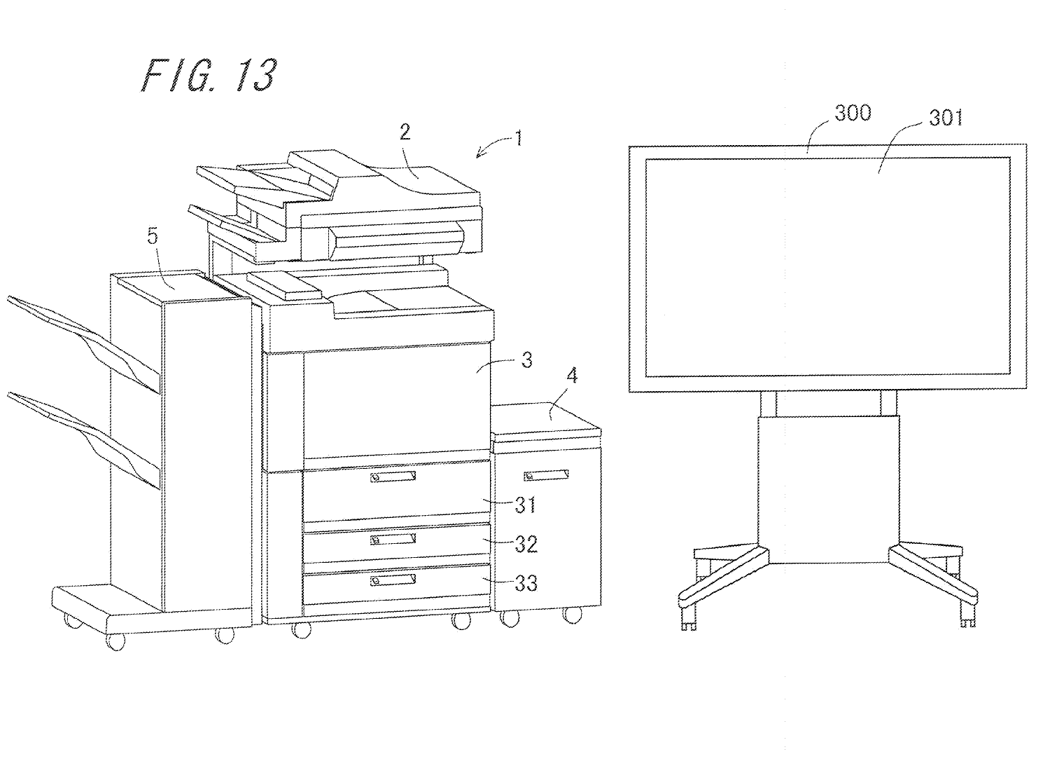

FIG. 13 is a diagram showing appearance of the image forming apparatus 1 and a display apparatus 300. The display apparatus 300 is a display apparatus with a very large screen called as a so-called electronic blackboard, an information display or the like.

Each of the electronic blackboard and the information display has a configuration connectable with a personal computer, an image forming apparatus, or the like in many cases, and is constituted so as to be able to perform data communication with the connection unit 505 of the image forming apparatus 1.

Here, the display apparatus 300 has two types of embodiments, the first one of which is to simply display a display screen that is displayed on the display unit 503 as with the large display units 200, 203 and 205.

A configuration of the display apparatus 300 is the same as that of an existing display apparatus, and provided with at least a control unit, a storage unit, a display panel 301, a coordinate input unit and a data communication unit. The connection unit 505 of the image forming apparatus 1 is connected to the data communication unit via wireless communication or wire communication so as to be able to perform data communication to receive from the image forming apparatus 1 image data that is created in the image forming apparatus 1 for displaying on the screen of the display unit 503. In the display apparatus 300, by the control unit, the same image as that of the display screen of the display unit 503 is displayed on a display panel based on the received image data.

The image data is sent to the display apparatus from the image forming apparatus 1 each time a screen displayed on the display unit 503 changes, and the same screen as one that is displayed on the display unit 503, for example, the use status display screen 75 shown in FIG. 6 or the new product display screen 78 shown in FIG. 8, is displayed on the display apparatus 300 at nearly the same time as the display unit 503.

The display apparatus 300 has a larger screen than those of the large display units 200, 203 and 205, and an effect for people around the image forming apparatus 1 is expected to become greater.

In the second embodiment of the display apparatus 300, not only the same screen as the screen that is displayed on the display unit 503 is displayed but also the same function as that of the manipulation panel 7 is included.

Each of the electronic blackboard and the information display is provided with a coordinate input device such as a touch panel, and thus displays the display screen shown in FIGS. 5 to 9 as with the manipulation panel 7, while making it possible to cause various icons such as a “RETURN” icon and a “PRINT” icon to effectively function. Accordingly, it is possible to realize the same manipulation as that of the manipulation panel 7 in the display apparatus 300. In the embodiment, only information of the acquisition equivalent, the actual equivalent, a comparison result thereof and the like is sent from the image forming apparatus 1 rather than sending image data to the display apparatus 300 from the image forming apparatus 1, and the display apparatus 300 that receives this creates and displays a use status display screen by itself based on the acquisition equivalent, the actual equivalent, the comparison result thereof and the like. Additionally, in a case where various icons are manipulated, a command based on the manipulated icon is sent to the image forming apparatus 1 from the display apparatus 300, and the image forming apparatus 1 that receives the command accepts the command as with a case where the manipulation panel 7 is manipulated to start settlement process or start printing process.

In this manner, the display apparatus 300 realizes improvement of an advertisement effect for the people around the image forming apparatus 1, and eventually further contribution to prevention of global warming, while making it possible to include a function as an external manipulation panel.

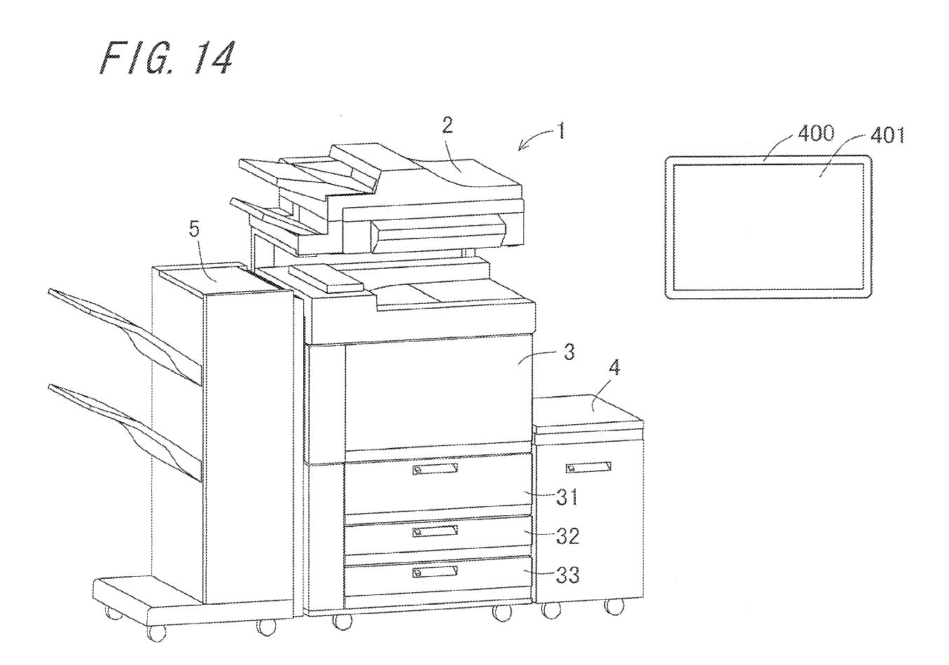

FIG. 14 is a diagram showing appearance of the image forming apparatus 1 and a display apparatus 400. The display apparatus 400 is a mobile terminal device represented by a so-called smartphone, tablet terminal or the like. The mobile terminal device is configured so as to be able to perform data communication with various information devices via, for example, wireless communication, and is able to perform data communication with the connection unit 505 of the image forming apparatus 1.

The display apparatus 400 has the same function as that of the display apparatus 300 except for a small-sized screen. The display apparatus 400 also has two types of embodiments as with the display apparatus 300 including an embodiment in which the same image as an image that is displayed on the display unit 503 is simply displayed, and an embodiment in which the same function as that of the manipulation panel 7 is included by manipulation of various icons. In the first embodiment, a user is able to confirm at hand a screen that is displayed on a display panel 401 of the display apparatus 400 even in a location that is far from the image forming apparatus 1. In the second embodiment, it is also possible to perform icon manipulation, and the image forming apparatus 1 is able to be remotely manipulated from a location that is far from the image forming apparatus 1.

In a sophisticated mobile terminal device such as a smartphone, in a case where a manufacturer or the like of the image forming apparatus 1 supplies application software, it is possible to add a remote controller function capable of easily performing remote manipulation of the image forming apparatus 1.

Note that, the above-described settlement process may be performed from warm-up of the image forming apparatus 1 until becoming a state being ready to be printable (hereinafter, also referred to as “Ready”), or may be performed during a print job (hereinafter, also referred to as “JOB”). Confirming process is performed during the either period, thereby successfully having an effect that another user uses the image forming apparatus without being disturbed.

According to the embodiment, the display unit 503 may include a liquid crystal display, an organic EL (Electro-Luminescence) display, a plasma display, a plasma tube array display, an electronic sheet display including an electrophoresis type, and an electron emission display.

The display unit 503 of the embodiment may be applied to products developed on the premise of uses other than in general households such as business equipment (corporations (companies or schools, government agencies)) and consumer equipment (electronic devices and equipment related to audiovisual and communications, or in a terminal, those intended for home use or the general consumer use, or refer to the product/specifications that are developed/designed on such a premise).

Additionally, in the embodiment, description has been made using a touch panel, however, gesture input using a Ubi-Finger device or the like may be used in place of the touch panel.

The technology is not limited to the exemplary embodiments described above, but various modifications can be made within the scope of the appended claims, and embodiments derived from arbitrary combination of the technical solution respectively disclosed in the different exemplary embodiments are also within the technical scope of the technology.

The technology may be embodied in other specific forms without departing from the spirit or essential characteristics thereof. The present embodiments are therefore to be considered in all respects as illustrative and not restrictive, the scope of the technology being indicated by the appended claims rather than by the foregoing description and all changes which come within the meaning and the range of equivalency of the claims are therefore intended to be embraced therein.

What is claimed is:

1. An image forming apparatus for forming an image, comprising:
an acquisition unit that acquires acquisition equivalent information indicating an acquisition equivalent in which an emission amount of greenhouse gases which are emitted by operation of the image forming apparatus, for which greenhouse gases emission rights are acquired, is converted to an emission amount of carbon dioxide, and actual equivalent information indicating an actual equivalent in which an emission amount of greenhouse gases which are emitted by operation of the image forming apparatus is converted to an emission amount of carbon dioxide, from a server that stores the acquisition equivalent information and the actual equivalent information and settles cost of emission rights;
a comparison unit that compares the acquisition equivalent indicated by the acquisition equivalent information that is acquired by the acquisition unit to the actual equivalent indicated by the actual equivalent information that is acquired by the acquisition unit;
a display unit that displays a comparison result of comparison performed by the comparison unit; and
a settlement unit that requests the server to settle cost for emission rights of greenhouse gases that are equal to a carbon dioxide equivalent which is a difference between the actual equivalent and the acquisition equivalent when the comparison result of comparison performed by the comparison unit shows that the actual equivalent is larger than the acquisition equivalent.

2. The image forming apparatus of claim 1, wherein the emission rights are acquired by a manufacturer or a dealer of the image forming apparatus.

3. The image forming apparatus of claim 1, further comprising a sending unit that sends an electric energy corresponding to an amount of electric power consumed for operation of an image forming apparatus, to the server,
wherein the actual equivalent is a value in which the server converts the electric energy sent by the sending unit to an emission amount of carbon dioxide.

4. The image forming apparatus of claim 1, further comprising an image forming apparatus main body that forms an image and one or more additional devices that are added to the image forming apparatus main body,
wherein the emission rights include emission rights for each of the image forming apparatus main body and the additional devices, and the whole image forming apparatus.

5. The image forming apparatus of claim 1, wherein the display unit is composed of a touch panel.

6. The image forming apparatus of claim 1, wherein the image forming apparatus is connected to the server by a communication line including a network.

7. The image forming apparatus of claim 1, wherein the comparison unit creates display image data for displaying a use status of emission rights based on the comparison result of comparison by the comparison unit and the acquisition equivalent as well as the actual equivalent, and
the display unit displays the use status of the emission rights based on the display image data.

8. A display apparatus configured to perform data communication with the image forming apparatus of claim 1, the display apparatus comprising:
a receiving unit that receives the acquisition equivalent, the actual equivalent and the comparison result of comparison by the comparison unit from the image forming apparatus; and
a use status display unit that displays a use status of emission rights based on the acquisition equivalent, the actual equivalent and the comparison result that are received by the receiving unit.

9. A display apparatus configured to perform data communication with the image forming apparatus of claim 7, the display apparatus comprising:
a receiving unit that receives the display image data from the image forming apparatus; and
a use status display unit that displays a use status of emission rights based on the display image data.

10. A greenhouse gas emission trading system comprising:
an image forming apparatus that forms an image; and
a server that stores acquisition equivalent information and actual equivalent information, and settles cost of emission rights, the acquisition equivalent information indicating an acquisition equivalent in which an emission amount of greenhouse gases which are emitted by operation of the image forming apparatus, for which greenhouse gases emission rights are acquired, is converted to an emission amount of carbon dioxide, and the actual equivalent information indicating an actual equivalent in which an emission amount of greenhouse gases which are emitted by operation of the image forming apparatus is converted to an emission amount of carbon dioxide,
the image forming apparatus comprising
an acquisition unit that acquires the acquisition equivalent information and the actual equivalent information from the server,
a comparison unit that compares the acquisition equivalent indicated by the acquisition equivalent information that is acquired by the acquisition unit to the actual equivalent indicated by the actual equivalent information that is acquired by the acquisition unit,
a display unit that displays a comparison result of comparison performed by the comparison unit, and
a settlement unit that requests the server to settle cost for emission rights of greenhouse gases that are equal to a carbon dioxide equivalent which is a difference between the actual equivalent and the acquisition equivalent when the comparison result of comparison performed by the comparison unit shows that the actual equivalent is larger than the acquisition equivalent.

11. A greenhouse gas emission trading method that is executed in a greenhouse gas emission trading system comprising an image forming apparatus that includes a display unit and forms an image, and a server that stores acquisition equivalent information and actual equivalent information, and settles cost of emission rights, the acquisition equivalent information indicating an acquisition equivalent in which an emission amount of greenhouse gases which are emitted by operation of the image forming apparatus, for which greenhouse gases emission rights are acquired, is converted to an emission amount of carbon dioxide, and the actual equivalent information indicating an actual equivalent in which an emission amount of greenhouse gases which are emitted by operation of the image forming apparatus is converted to an emission amount of carbon dioxide, the greenhouse gas emission trading method comprising:
an acquisition step of acquiring the acquisition equivalent information and the actual equivalent information from the server;
a comparison step of comparing the acquisition equivalent indicated by the acquisition equivalent information that is acquired in the acquisition step to the actual equivalent indicated by the actual equivalent information that is acquired in the acquisition step;
a display step of displaying on the display unit a comparison result of comparison performed in the comparison step; and
a settlement step of requesting the server to settle cost for emission rights of greenhouse gases that are equal to a carbon dioxide equivalent which is a difference between the actual equivalent and the acquisition equivalent when the comparison result of comparison performed in the comparison step shows that the actual equivalent is larger than the acquisition equivalent.
